(19) United States
(12) Patent Application Publication
(10) Pub. No.: US 2025/0365779 A1
(43) Pub. Date: Nov. 27, 2025

(54) EDCA BACKOFF RESTART PROCEDURES AND STATE SWITCHES IN EMLSR OR EMLMR CO-AFFILIATED STATIONS

(71) Applicant: CANON KABUSHIKI KAISHA, Tokyo (JP)

(72) Inventors: Mickaël LORGEOUX, RENNES (FR); Julien SEVIN, SAINT AUBIN DU CORMIER (FR); Pascal VIGER, JANZE (FR)

(21) Appl. No.: 18/867,410

(22) PCT Filed: Jun. 12, 2023
(86) PCT No.: PCT/EP2023/065692

§ 371 Date: Nov. 19, 2024

(30) Foreign Application Priority Data
Jun. 10, 2022 (GB) 2208552.6
Jun. 10, 2022 (GB) 2208553.4

(51) Int. Cl. H04W 74/0833; H04W 74/00; H04W 74/0816

(52) U.S. Cl. CPC H04W 74/085; H04W 74/002; H04W 74/0816

(57) ABSTRACT

An EMLSR-active non-AP MLD desires to initiate a frame exchange with the AP MLD over one of the EMLSR links. A first link is chosen and the corresponding “first” affiliated STA invokes and starts an EDCA backoff procedure that decrements one or more backoff counters, to access the first link. Alternatively, each EMLSR co-affiliated STA may invoke an EDCA backoff procedure to access their respective link. In embodiments, the first affiliated STA is switched from a listening operation state to an enabled frame exchange state, before invoking the EDCA backoff procedure. In other embodiments, the first affiliated STA first invokes the EDCA backoff procedure, and is switched to the enabled frame exchange state when the backoff counter expires. A corresponding state switching procedure may be invoked so that it ends with the expiry of the backoff counter, or responsive to an expiry of the backoff counter.

### FIELD OF THE INVENTION

The present invention generally relates to wireless communications and more specifically to Multi-Link (ML) communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE-RTM) provides a great number of mechanisms for wireless communications between STAs.

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D1.5 version (March 2022, below “D1.5 standard”) introduces the Multi-Link (ML) Operation (MLO). MLO improves data throughput by allowing communications between STAs over multiple concurrent and non-contiguous communication links.

MLO enables a non-AP (Access Point) MLD (ML Device) to register with an AP MLD, i.e. to discover, authenticate, associate and set up multiple links with the AP MLD. Each link enables channel access and frame exchanges between the non-AP MLD and the AP MLD based on supported capabilities exchanged during the association procedure.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP STAs. The affiliated STAs in both AP MLD and non-AP MLD can use 802.11 mechanisms to communicate with affiliated STAs of another MLD over each of the multiple communication links that are set up.

With the introduction of MLO and of spatial multiplexing capabilities of the MLDs, new Operating Modes (OM) referred to as Enhanced Multi-Link Operating Mode (EML OM), have been introduced in the D1.5 standard, namely the EMLSR (Enhanced Multi-Link Single Radio) mode and the EMLMR (Enhanced Multi-Link Multi-Radio) mode.

The non-AP MLDs declare their support of the EML Operating Modes (known as EML Capabilities) to the AP MLD during the association phase. In operation mode, the activation and the deactivation of an EML Operation Mode is initiated by the non-AP MLD which sends a specific EHT action frame referred to as “EML OM Notification”. The D1.5 standard states that the two EMLSR and EMLMR modes are mutually exclusive.

The EMLMR mode, once activated, allows the non-AP MLD to simultaneously listen to a set of enabled links (so-called EMLMR links, usually made of two enabled links) to receive an initial frame transmitted by the AP MLD to initiate frame exchange and next to aggregate some physical resources of its different radios used on different links (so-called EMLMR links) in order to transmit or receive data up to a pre-defined number of supported Rx/Tx spatial streams, over only one EMLMR link at a time, usually the link over which the initial frame is received. The number may be greater than the number of supported Rx/Tx spatial streams of each radio.

The EMLSR mode, once activated, allows a non-AP MLD to simultaneously listen to a set of enabled links (so-called EMLSR links, usually made of two enabled links) to receive an initial control frame (e.g. an MU-RTS trigger frame, a BSRP trigger frame) from the AP MLD to initiate frame exchange and next to perform data frames exchange with the AP MLD over only one EMLSR link at a time, usually the link over which the initial control frame is received.

In addition, the non-AP MLD has also the ability to initiate itself the frame exchange with the AP MLD over one EMLSR or EMLMR link for transmitting uplink data. In such a case, a STA affiliated with a non-AP MLD operating in the EMLSR or EMLMR mode does not need to transmit an initial Control frame or an initial frame to initiate frame exchanges with the AP MLD (untriggered UL transmission) and follows the rules defined in sections 10.3.2.4 (Setting and resetting the NAV) and 10.23.2 (HCF contention based channel access (EDCA)) to access the wireless medium as specified in the IEEE 802.11-2020 standard.

However, the legacy contention-based channel access procedure, such as EDCA, is not fully adapted to the EML modes where the EMLSR or EMLMR links are not entirely independent one of the other. There is thus a need to improve the EDCA procedures in case of EML modes.

### SUMMARY OF INVENTION

It is a broad objective of the present invention to provide enhanced contention-based channel access procedures adapted to the EML modes, which take into account the EML capabilities related to the active EML mode, be it EMLSR or EMLMR.

A communication method in a wireless network according to the invention may comprise, at a non-access point, non-AP, multi-link device, MLD operating in an active Enhanced Multi-Link, EML, mode:
invoking, by a first station, STA, affiliated with the non-AP MLD and corresponding to a first link of a set of enabled links in which links the EML mode is applied, an enhanced distributed channel access, EDCA, backoff procedure decrementing a backoff counter, to access the first link; and
switching the first affiliated STA from a listening operation state to an enabled frame exchange state for initiating a frame exchange with an AP MLD over the first link.

In embodiments, switching the first affiliated STA to the enabled frame exchange state is performed before invoking, by the first affiliated STA in the enabled frame exchange state, the EDCA backoff procedure for decrementing the backoff counter.

For example, the communication method in a wireless network may therefore comprise, at a non-access point, non-AP, multi-link device, MLD operating in an active Enhanced Multi-Link, EML, mode:
initiating, by a first STA affiliated with the non-AP MLD and corresponding to a first link of a set of enabled links in which links the EML mode is applied, a frame exchange with an AP MLD over the first link,
wherein initiating the frame exchange includes:
switching the first affiliated STA from a listening operation state to an enabled frame exchange state, before invoking, by the first affiliated STA in the enabled frame exchange state, an enhanced distributed channel access, EDCA, backoff procedure decrementing a backoff counter, to access the first link.

In these embodiments, the EDCA backoff procedure is not impacted by the STA state switch. This first affiliated STA is therefore ready to perform the frame exchange as soon as the backoff counter expires.

In other embodiments, switching the first affiliated STA to the enabled frame exchange state is performed when the backoff counter reaches a value of 0.

For example, the communication method in a wireless network may therefore comprise, at a non-access point, non-AP, multi-link device, MLD operating in an active Enhanced Multi-Link, EML, mode:
initiating, by a first STA affiliated with the non-AP MLD and corresponding to a first link of a set of enabled links in which links the EML mode is applied, a frame exchange with an AP MLD over the first link,
wherein initiating the frame exchange includes:
invoking, by the first affiliated STA in a listening operation state, an enhanced distributed channel access, EDCA, backoff procedure decrementing a backoff counter, to access the first link, and
switching the first affiliated STA from the listening operation state to an enabled frame exchange state, when the backoff counter reaches a value of 0.

In these embodiments, the other co-affiliated STA of the non-AP MLD is still in the listening operation state while the backoff counter is decremented. This means that the AP MLD can still initiate a frame exchange with this other co-affiliated STA despite the counter decrement by the first affiliated STA. This improves network communications.

In other embodiments that efficiently drive EDCA over the EMLSR or EMLMR links to mirror their dependencies, responsive to starting a frame exchange with the AP MLD over a second link of the set of enabled links in which links the EML mode is applied, suspending the backoff counter driving the EDCA to the first link of the set.

For example, the communication method in a wireless network may therefore comprise, at a non-access point, non-AP, multi-link device, MLD operating in an active Enhanced Multi-Link, EML, mode:

responsive to starting a frame exchange with an AP MLD over a second link of a set of enabled links in which links the EML mode is applied, suspending a backoff counter driving an enhanced distributed channel access, EDCA, to a first link of the set.

Accordingly, a specific event occurring on the second link has direct impact on the first and separate link of the same EMLSR or EMLMR links. Contrary to known techniques, the suspension of the backoff counters to access a medium (link) no longer depends on only the idle/busy status of the targeted medium, but now depends on the activity (frame exchange) over the other EMLSR/EMLMR link. This avoids obtaining EDCA access to the first link while the corresponding co-affiliated STA is not available (because the radio resources have been allocated to the co-affiliated STA due to the frame exchange). It turns outs that the efficiency of the EDCA procedure is improved.

Although only one first link of the set is mentioned here, the invention may apply to plural other links (different from the second link) of the EMLSR/EMLMR links set.

Optional features of the invention are defined below with reference to a method, while they can be transposed into device features.

In some embodiments where the decrement is performed while the first affiliated STA is in the enabled frame exchange state, the method further comprises, upon detecting the first link becomes busy during the decrement of the backoff counter, suspending the decrement and applying one from plural policies.

As an example, policy a) includes keeping the first affiliated STA in the enabled frame exchange state and resuming the decrement once the first link becomes idle again.

As another example, policy b) includes switching the first affiliated STA back to the listening operation state regardless of a duration specified in a frame based on which the detection is made.

As yet other example, policy c) includes switching the first affiliated STA back to the listening operation state for a predefined time period that is based on a duration specified in a frame based on which the detection is made, before switching again to the enabled frame exchange state to resume the decrement if the first link is idle again.

As yet other example, policy d) includes determining a duration specified in a frame based on which the detection is made, and depending on the determined duration, deciding to apply one or the other of policies a), b) or c).

In some embodiments where the decrement is performed while the first affiliated STA is in the listening operation state, the method further comprises suspending the EDCA backoff procedure (i.e. the decrement of the backoff counter or counters is stopped) upon receiving an initial frame from the AP MLD over a second link of the set. The initial frame is understood as being a frame initiating a frame exchange on AP MLD initiative. The initial frame is known under this name for the EMLMR mode and under the “initial control frame” for the EMLSR mode. The non-AP MLD may therefore engage a new frame exchange initiated by the AP over the second link. This is made possible because the other co-affiliated STA corresponding to the second link is still in the listening operation state while the backoff counter is decremented.

More generally, the method may further comprise, upon receiving an initial frame from the AP MLD over a second link of the set, deciding whether to suspend the EDCA backoff procedure based on one from plural criterions.

As a first example, a criterion may include determining whether the first affiliated STA is allocated a full radio resource.

As another example, a criterion may include determining whether the initial frame is a MU-RTS Trigger frame.

As yet other example, a criterion may include determining whether uplink data have already been preloaded in a transmission associated to the first link only, compared to the second link).

As yet other example, a criterion may include determining whether an amount of buffered data is higher than a threshold.

These embodiments may be envisioned independently of the core definition of the invention above. As an independent concept, they regard a communication method in a wireless network, comprising, at a non-access point, non-AP, multi-link device, MLD operating in an active Enhanced Multi-Link, EML, mode:
invoking, by a first STA in a listening operation state and affiliated with the non-AP MLD and corresponding to a first link of a set of enabled links in which links the EML mode is applied, an enhanced distributed channel access, EDCA, backoff procedure decrementing a backoff counter, to access the first link,
wherein the decrement of the backoff counter is suspended upon receiving an initial frame from the AP MLD over a second link of the set. More generally, upon receiving an initial frame from the AP MLD over a second link of the set, it is decided whether to suspend the decrement of the backoff counter.

In some embodiments of the invention, switching the first affiliated STA includes invoking a state switching procedure for the first affiliated STA while the first affiliated STA is decrementing the backoff counter so that the state switching procedure ends simultaneously to the backoff counter reaching the value of 0. The first affiliated STA is therefore ready to immediately perform the frame exchange upon expiry of the backoff counter. This increases communication performance.

In other embodiments, switching the first affiliated STA includes invoking a state switching procedure for the first affiliated STA, responsive to the backoff counter reaching the value of 0. In this case, the first affiliated STA has not changed state when an activity is sensed when the backoff counter is nearly expiring. This approach saves the opportunity for the other co-affiliated STA to access its medium. Hence, communication performance is improved.

In particular embodiments, the method further comprises, responsive to the backoff counter reaching the value of 0, transmitting a control frame over the first link. The control frame may be a CTS-to-self frame or a RTS frame. This is to protect the gained medium, should another MLD wishes to access the same medium while the non-AP MLD is switching the states of its co-affiliated STAs. This also contributes to improve the communication performance of the network.

According to specific features, the control frame includes padding to end the control frame after a time point that precedes an end of the state switching procedure by a short interframe space, SIFS. This ensures the protection of the medium is made for all the transition period where the co-affiliated STAs are switched.

According to other specific features, the first affiliated STA is allocated a light radio resource in the listening operation state while a separate and second STA affiliated with the non-AP MLD and corresponding to a second link of the set is allocated a full radio resource in the listening operation state. Indeed, the above protection is worth to be implemented when the “active” EMLSR co-affiliated STA (here the first STA) is initially configured with the light radio stack, hence requires a longer time to be configured with the full radio stack (during the switch) in case of EMLSR mode.

In some embodiments, the method comprises setting a network allocation vector, NAV, of the first affiliated STA in the listening operation state, upon sensing over the first link any control frame having a MCS value up to 2. This extends the processing of frames by the affiliated STA in the listening operation state to more than only the initial control frames (MU-RTS and BSRP trigger frames).

In some embodiments, the method comprises simultaneously invoking EDCA backoff procedures on two or more links of the set, wherein the first link is the link corresponding to a backoff counter of the EDCA backoff procedures that first reaches the value of 0. In other words, an EDCA backoff procedure is also invoked by a separate and second affiliated STA in a listening operation state corresponding to a second link of the set, simultaneously to the invocation by the first affiliated STA of the EDCA backoff procedure. This increases the chances for the non-AP MLD to access a wireless network, hence improves communication performance.

In some embodiments, the method further comprises, simultaneously to the switching of the first affiliated STA, switching a separate and second STA affiliated with the non-AP MLD and corresponding to a second link of the set, from a listening operation state to a disabled frame exchange state.

In some embodiments, the method further comprises switching the first and second affiliated STAs back to the listening operation state upon ending the frame exchange over the first link.

In some embodiments, initiating the frame exchange excludes transmitting an initial frame to the AP MLD over the first link. This explicitly indicates that the invention is directed to an untriggered uplink transmission of the non-AP MLD in the EML mode.

In some embodiments, the method further comprises performing the frame exchange with the AP MLD over the first link, usually an uplink transmission because on non-AP MLD's initiative, after the backoff counter reaches a value of 0.

Particular EDCA-related issues occur after an UpLink (UL) transmission on a second EMLSR or EMLMR link, because a systematic usage of the legacy EDCA backoff resumption or restart procedure for a first EMLSR or EMLMR link of the EMLSR or EMLMR Links set is not adapted, in particular with respect to fairness issues in accessing the wireless network.

That is why it is also an objective of embodiments of the invention to provide EDCA backoff resumption or restart procedures adapted to the EML modes, which take into account the EML capabilities. Especially, some embodiments of the invention specify novel EDCA backoff resumption or restart procedures for a STA affiliated with a non-AP MLD operating on a first EMLSR or EMLMR link after an UL transmission took place on a second EMLSR or EMLMR link of the same EMLSR or EMLMR Links set.

In this context, the method may further comprises, still at the non-AP MLD, responsive to ending the frame exchange over the second link, applying a backoff restart strategy selected based on a property of the frame exchange, to restart the backoff counter.

A “restart” of a backoff counter is to be understood as any technics to start again the decrement of the backoff counter, regardless of whether the decrement is resumed from the last known/current value of the counter or is started again from a new counter value reinitializing the backoff counter. Those various options are described with more details below.

Accordingly, the strategy or policy to restart a backoff counter for a given link is made dependent on what happened (frame exchange) on another link, contrary to conventional approaches regarding the EDCA procedure. It turns out that the network access fairness issue can be mitigated by adopting or adjusting appropriate EDCA backoff restart procedures. In particular, the backoff counter associated with an AC for a given link may be penalized when data from the same AC have just been transmitted over another link of the same EMLSR or EMLMR links set.

In some embodiments, a property of the frame exchange includes whether the frame exchange includes single-user uplink transmission to the AP MLD or multi-user triggered-based uplink transmission to the AP MLD or only downlink transmission from the AP MLD. This allows the network to adjust the penalty depending on whether the non-AP MLD obtain additional transmission opportunities (e.g. through trigger-based UL) compared to conventional EDCA (single user UL) or even to downlink transmission.

In some embodiments, a property of the frame exchange includes whether the frame exchange is a successful uplink transmission to the AP MLD or a failed one. This allows the network to adjust the penalty should the non-AP MLD successfully takes advantage of its transmission opportunities or not.

Of course, the above embodiments (SU or MU transmission as a property and transmission success of failure as another property) are preferably combined, meaning taking into account as well the SU UL or MU UL or DL nature of the transmission and the successful or failed status of the transmission. Of course, other properties of the frame exchange can be used in the selection of the restart strategy or procedure.

In some embodiments, the applied restart strategy includes one from:
reinitializing the backoff counter using a current contention window, before starting decrementing the backoff counter,
reinitializing the backoff counter using a new contention window associated with a new EDCA mode, before starting decrementing the backoff counter. It should be understood that the new EDCA mode is considered as being “new” compared to the current EDCA mode of the concerned affiliated STA. For example, the STA operating on the second link may switch from the legacy EDCA mode to a multi-user EDCA, MU EDCA, mode having its own MU EDCA parameters including own contention window values. Alternatively, a new EML EDCA mode (e.g. EMLSR EDCA mode and/or EMLMR EDCA mode) may be defined, having its own EML EDCA parameters including own contention window values penalizing more or less the concerned AC, in which case the STA operating on the second link may switch from the legacy EDCA mode to the EML EDCA mode.
resuming the backoff counter from a current value, possibly switching to another EDCA mode in order to penalize the backoff counter for the next reinitialization.

The use of a new EML EDCA mode is substantially different from the known 802.11 techniques where only the EDCA mode and MU EDCA mode are known. The EML EDCA mode may correspond to a specific set of EML EDCA parameters different from the EDCA parameters and the MU EDCA parameters, in that they are transmitted by the affiliated AP to the co-affiliated STA (through beacon frame or probe response frame) separately from the EDCA parameters and the MU EDCA parameters. The EML EDCA parameters may be specific to each link, hence possibly different one link from the other, or may be set to the same values throughout the EMLSR or EMLMR Links set. Similar, but distinct, fields may be provided in the beacon/probe response frames to convey these parameters over each link.

Correspondingly, a communication method in a wireless network, may comprise, at a non-access point, non-AP, multi-link device, MLD operating in an active Enhanced Multi-Link, EML, mode:
responsive to ending a frame exchange with the AP MLD over a first link of a set of enabled links in which links the EML mode is applied, switching enhanced distributed channel access, EDCA, parameters of a backoff counter driving an EDCA to a second link of the set from current EDCA parameters to different EML EDCA parameters. This defines an EML EDCA mode for the co-affiliated STA operating on the second link. An EML EDCA mode may be engaged in each links of the set different from the first link, if they are plural. The EML EDCA mode per each link may use link-specific EML EDCA parameters, or alternatively share the same EML EDCA parameters.

In that way, a penalization of the EDCA for the non-AP MLD may be adjusted to the active EML mode.

In embodiments, the frame exchange includes a (preferably successful) trigger-based uplink transmission to the AP MLD.

In some embodiments, the method further includes, responsive to ending the frame exchange with the AP MLD over the first link, switching EDCA parameters of a backoff counter driving an EDCA to the first link from current EDCA parameters to different EML EDCA parameters. In other words, the first link where the frame exchange takes place is penalized in the same way as the other EMLSR/EMLMR links of the set. The concerned backoff counter is the one corresponding to an AC transmitted during the frame exchange.

In other embodiments, the non-AP MLD stores a set of EML single-radio, EMLSR, EDCA parameters and a set of EML multi-radio, EMLMR, EDCA parameters, wherein the different EML EDCA parameters are selected from the set of EMLSR EDCA parameters and the set of EMLMR EDCA parameters depending on whether the non-AP MLD is in an EMLSR mode or in an EMLMR mode respectively.

In other embodiments, the method further comprises receiving, from the AP MLD, a management frame (beacon or probe response frame) including the different EML EDCA parameters, possibly in addition to EDCA parameters and to MU EDCA parameters. Correspondingly, a communication method in a wireless network, may comprise, at an access point, AP, multi-link device, MLD capable to operate in an active Enhanced Multi-Link, EML, mode:
sending a management frame to non-AP MLDs, wherein the management frame includes a set of EML EDCA parameters,
wherein the EML EDCA parameters are used to configure an enhanced distributed channel access, EDCA, of a non-AP MLD operating in the EML mode to drive access to a first link of a set of enabled links in which links the EML mode is applied when a frame exchange with the AP MLD ends over a second link of the set.

Therefore, a new set of EDCA parameters is defined to penalize the co-affiliated STAs when obtaining additional transmission opportunities (usually through trigger based UL transmissions) while they operate with an EML mode.

The set of EML (or EMLSR and/or EMLMR) EDCA parameters may be additional to a set of EDCA parameters within the management frame, and/or additional to a set of MU EDCA parameters within the management frame.

In particular embodiments, the applied restart strategy includes one from:
resuming the backoff counter from a current value, in case of downlink transmission or failed uplink transmission in the frame exchange,
reinitializing the backoff counter using a current contention window, before starting decrementing the backoff counter or resuming the backoff counter from a current value, in case of successful single-user uplink transmission in the frame exchange,
reinitializing the backoff counter using a current contention window or a new contention window associated with a new EDCA mode, before starting decrementing the backoff counter, or resuming the backoff counter from a current value (possibly switching the STA to another EDCA mode—e.g. MU EDCA mode or EML EDCA mode as defined above—in order to penalize the backoff counter for the next reinitialization), in case of successful multi-user triggered-based uplink transmission in the frame exchange.

In some embodiments, plural backoff counters driving EDCA to the first link for respective plural access categories are suspended in response to starting the frame exchange, and

the restart strategy is applied to the backoff counter or counters of the plural suspended backoff counters that correspond to access categories exchanged during the frame exchange.

Hence, all ACs benefiting from the frame exchange can be penalized through the applied restart strategy.

In some embodiments, the restart strategy includes a synchronization delay from the end of the frame exchange, before restarting the backoff counter. This allows the co-affiliated STA dedicated to the inactive link during the frame exchange to resynchronize with the medium.

In particular embodiments, including the synchronization delay in the restart strategy is conditional to a duration of the frame exchange greater than a predefined threshold. Such delay and threshold may be, respectively, the MediumSyncDelay and aMediumSyncThreshold defined in the D1.5 standard. This configuration avoids for the co-affiliated STA to waste time before contending again for an access to the medium, when the STA has not desynchronized from the medium.

According to specific features, a timer counting down the synchronization delay is initialized with a Medium Synchronization value provided by the AP MLD (e.g. in the Basic Multi-Link element of the most recently received frame from associated affiliated AP) over the first link. In particular, the timer may be set to 0 upon successful reception, over the first link, of a Control frame having a MCS value set up to 2. Again, this is to avoid time to be waste before contending again for an access to the medium, as soon as the STA has resynchronized with the medium (thanks to the successfully received frame).

In some embodiments, starting a frame exchange includes detecting an expiry of another backoff counter driving an EDCA to the second link. Preferably, the backoff counter and the other backoff counter are associated with the same access category. In this configuration, the co-affiliated STA of the second link gains access to that link for SU transmission of a particular AC. The restart strategy is therefore applied to the backoff counter corresponding to the same particular AC, for the other link. This ensures appropriate fairness handling between the ACs.

In other embodiments, starting a frame exchange includes receiving an initial frame (including the known initial control frame in the EMLSR mode) over the second link from the AP MLD. In particular, the initial frame may be received while another backoff counter driving an EDCA to the second link is being decremented.

In some embodiments, the method further comprises, responsive to ending the frame exchange over the second link, applying another restart strategy based on a property of the frame exchange, to restart another backoff counter driving an EDCA to the second link.

In embodiments, the other restart strategy includes one from:
reinitializing the other backoff counter using an updated contention window, before starting decrementing the other backoff counter, in case where the other backoff counter has expired,
resuming the other backoff counter from a current value, otherwise, possibly with a switch of the backoff engine to another EDCA mode (e.g. MU EDCA mode or any EML EDCA mode as defined above) in order to penalize the backoff counter for the next reinitialization, in case of successful trigger-based UL transmission. In some embodiments, the other EDCA mode is the same as the new EDCA mode entered by the co-affiliated STA operating on the first link, meaning both (or more) co-affiliated STAs switch to the same other EDCA mode (MU EDCA mode or EML EDCA mode), even if the set of MU or EML EDCA parameters they respectively use may be different because specific to each link. Alternatively, the co-affiliated STA operating on the second link may either remain in the conventional EDCA mode or merely switch to the MU EDCA mode (because it benefited from a trigger-based UL transmission), while the co-affiliated STA operating on the first link switches to the EML MU mode.

In some embodiments, the method further comprises, responsive to starting the frame exchange, switching a second STA affiliated with the non-AP MLD and corresponding to the second link from a listening operation state to an enabled frame exchange state and switching the first STA affiliated with the non-AP MLD and corresponding to the first link from a listening operation state to a disabled frame exchange state.

Correlatively, the invention also provides a wireless communication device comprising at least one microprocessor configured for carrying out the steps of any of the above methods. The wireless communication device is a non-AP MLD.

In particular, a non-access point, non-AP, multi-link device, MLD, capable of operating in an active Enhanced Multi-Link, EML, mode, the non-AP MLD may comprise:
means for invoking, by a first station, STA, affiliated with the non-AP MLD and corresponding to a first link of a set of enabled links in which links the EML mode can be applied, an enhanced distributed channel access, EDCA, backoff procedure decrementing a backoff counter, to access the first link; and
means for switching the first affiliated STA from a listening operation state to an enabled frame exchange state for initiating a frame exchange with an AP MLD over the first link.

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions between EML-capable MLDs in which the present invention may be implemented;

FIGS. 1a and 1b illustrate an exemplary 802.11be multi-link reference model for a MLD either AP MLD or non-AP MLD;

FIG. 2 schematically illustrates an exemplary sequence of frames of the EMLSR Operating Mode as specified in D1.5 standard;

FIG. 3 illustrates, using flowcharts, steps performed by an EMLSR-active non-AP MLD to operate a first contention-based channel access procedure, according to first embodiments;

FIG. 4 schematically illustrates an exemplary timeline of the first contention-based channel access procedure as described in FIG. 3;

FIG. 5 illustrate, using flowcharts, steps performed by an EMLSR-active non-AP MLD to operate a second contention-based channel access procedure, according to second embodiments;

FIG. 6a schematically illustrates an alternative timeline of the second contention-based channel access procedure as described in FIG. 5;

FIG. 6b schematically illustrates more detailed scenarios of FIG. 6a taking into account a transition period during which the states of the EMLSR co-affiliated STA are switched;

FIG. 7 illustrates, using flowcharts, steps performed by an EMLSR-active non-AP MLD to operate a third contention-based channel access procedure, according to third embodiments;

FIG. 8 schematically illustrates an exemplary timeline of the third contention-based channel access procedure as described in FIG. 7;

FIG. 9 illustrates, using flowcharts, steps handling backoff counter restart in an EML mode, according to embodiments;

FIGS. 10a and 10b schematically illustrates an exemplary timeline of a first EMLSR or EMLMR operation case involving a backoff counter restart procedure according to embodiments;

FIG. 11 schematically illustrates an exemplary timeline of a second EMLSR or EMLMR operation case involving a backoff counter restart procedure according to other embodiments when a triggering event of the frame exchange is the reception of an initial frame;

FIG. 12 schematically illustrates an exemplary timeline of a third EMLSR or EMLMR operation case involving a backoff counter restart procedure according to yet other embodiments, still when a triggering event of the frame exchange is the reception of an initial frame;

FIG. 13 illustrates a table gathering proposed EDCA backoff counter restart procedures or policies according to embodiments;

FIG. 14 schematically illustrates an EMLSR capable architecture for an MLD to implement embodiments of the invention;

FIG. 15 schematically illustrates an EMLMR capable architecture for an MLD to implement embodiments of the invention; and

FIG. 16 shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e., wireless devices or STAs. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., STAs). In some aspects, a wireless device or STA implemented in accordance with the teachings herein may comprise an access point (so-called AP) or not (so-called non-AP STA or STA).

While the examples are described in the context of WiFi (RTM) networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base STA (gNB), Base STA Controller (“BSC”), Base Transceiver STA (“BTS”), Base STA (“BS”), Transceiver Function (“TF”), Radio Router, Radio Transceiver, Basic Service Set (“BSS”), Extended Service Set (“ESS”), Radio Base STA (“RBS”), or some other terminology.

A non-AP STA may comprise, be implemented as, or known as a subscriber STA, a subscriber unit, a mobile STA (MS), a remote STA, a remote terminal, a user terminal (UT), a user agent, a user device, user equipment (UE), a user STA, or some other terminology. In some implementations, a STA may comprise a cellular telephone, a cordless telephone, a Session Initiation Protocol (“SIP”) phone, a wireless local loop (“WLL”) STA, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP STA may be a wireless node. Such wireless node may provide, for example, connectivity for or to a network (e.g., a wide area network such as the Internet or a cellular network) via a wired or wireless communication link.

An AP manages a set of STAs (registered to it or associated with it) that together organize their accesses to the wireless medium for communication purposes. The STAs (including the AP to which they register) form a service set, here below referred to as basic service set, BSS (although other terminology can be used). A same physical STA acting as an access point may manage two or more BSS (and thus corresponding WLANs): each BSS is thus uniquely identified by a specific basic service set identification, BSSID and managed by a separate virtual AP implemented in the physical AP. Each STA is identified within a BSS thanks to an identifier, AID, assigned to it by the AP upon registration.

The 802.11 family of standards define various media access control (MAC) mechanisms to drive access to the wireless medium.

The current discussions in the task group 802.11be, as illustrated by draft IEEE P802.11be/D1.5 of March 2022, introduce the Multi-Link Operation (MLO) when it comes to MAC layer operation. The MLO allows multi-link devices to establish or setup multiple links and operate them simultaneously.

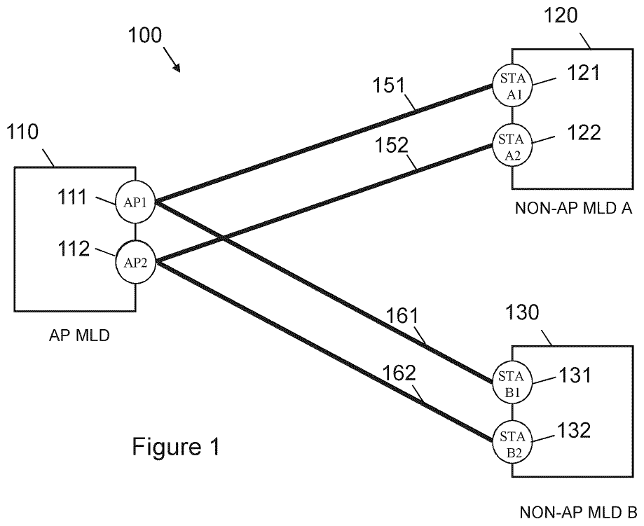

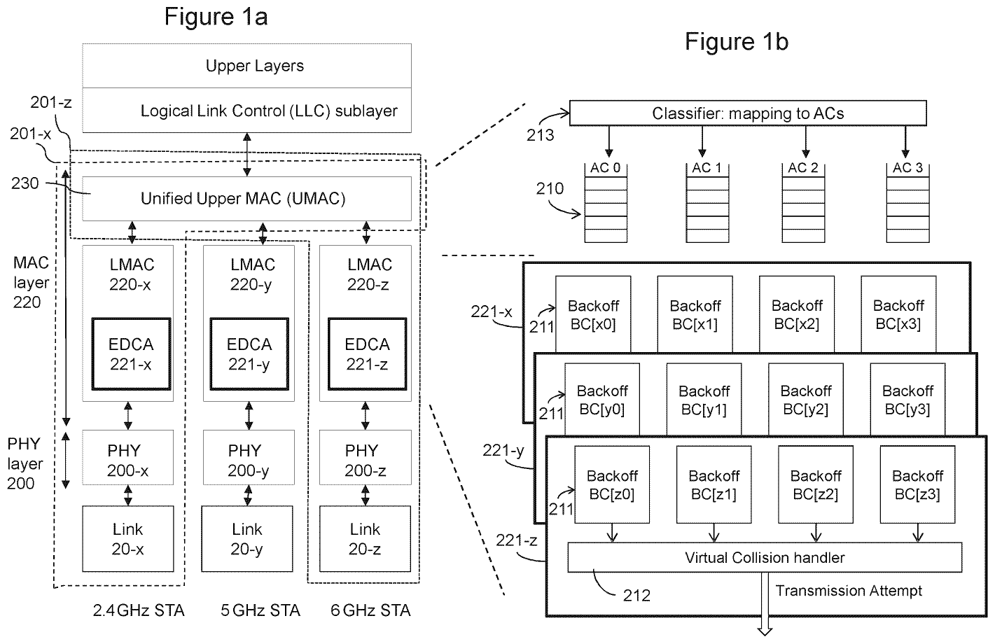

A Multi-Link Device (MLD) is a logical entity and has more than one affiliated STA (STA) and has a single medium access control (MAC) service access point (SAP) to logical link control (LLC), which includes one MAC data service. An Access Point Multi-Link Device (or AP MLD) then corresponds to a MLD where each STA affiliated with the MLD is an AP, hence referred to as “affiliated AP”. A non-Access Point Multi-Link Device (or non-AP MLD) corresponds to a MLD where each STA affiliated with the MLD is a non-AP STA, referred to as “affiliated non-AP STA”. Depending on the literature, “multilink device”, “ML Device” (MLD), “multilink logical entity”, “ML logical entity” (MLE), “multilink set” and “ML set” are synonyms to designate the same type of ML Device. An illustrative architecture of a Multi-Link Device is described below with reference to FIGS. 1a and 1b.

Multiple affiliated non-AP STAs of a non-AP MLD can then setup communication links with multiple affiliated APs of an AP MLD, hence forming a multi-link channel.

The links established (or “enabled links”) for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g., 20 MHz, 40 MHz, and so on) in a given frequency band (e.g., 2.4 GHZ, 5 GHZ, 6 GHZ) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

From architecture point of view, a MLD contains typically several radios in order to implement its affiliated STAs but not necessary a number equal to its number of affiliated STAs. In particular, a non-AP MLD may operate with a number of affiliated STAs greater than its number of radios (which can even be reduced to a single one).

Several Enhanced Multi-Link Operating Modes (or EML OMs in short) have been defined by the D1.5 standard from this physical architecture, namely the Enhanced Multi-Link Single Radio (EMLSR) and the Enhanced Multi-Link Multi Radio (EMLMR). The D1.5 standard states that the two EMLSR and EMLMR modes are mutually exclusive.

Any non-AP MLD declares its support of the EMLSR and/or EMLMR mode (in its so-called EML Capabilities) to the AP MLD during the association phase. In operation mode, the activation and the deactivation of the EMLSR or EMLMR Mode is initiated by the non-AP MLD which sends a specific EHT action frame referred to as “EML OM Notification”, indicating in particular the set of enabled links (so-called EMLSR or EMLMR links) in which the EMLSR or EMLMR mode to activate is applied. Usually the set “EMLSR/EMLMR links” is made of two enabled links. However, a greater number of enabled links may be used.

The EMLSR mode, once activated, allows the non-AP MLD to simultaneously listen to the enabled links of the set “EMLSR links” to receive initial control frames (e.g. MU-RTS trigger frames or BSRP trigger frames) transmitted by the AP MLD and next to perform data frames exchange with the AP MLD over only one link at a time, usually the link over which the initial control frame is received. Each non-AP MLD may support or not the EMLSR operating mode.

In the EMLMR mode, a non-AP MLD is able to aggregate some physical resources of multiple radios dedicated to multiple enabled links (so-called EMLMR links), in order to transmit or receive data up to a pre-defined number of supported Rx/Tx spatial streams. This predefined number is higher than the number of supported Rx/Tx spatial streams per each radio, hence providing throughput enhancement and latency reduction. As an example, a multi-radio (MR) non-AP MLD supporting the EMLMR mode on two links (with associated radios) communicates over the two links using the two respective radios when the EMLMR mode is deactivated, for example in a 2×2 MIMO antenna configuration for each radio. On the other hand, the MR non-AP MLD communicates over one of the two links using one of its radios with the aggregated physical resources of the two radios (typically the antennas) when the EMLMR mode is activated, for example in a 4×4 MIMO antenna configuration. In the same time, the other link (deprived of its physical antenna) cannot be used.

The EMLMR mode, once activated, allows the non-AP MLD to simultaneously listen to the enabled links of the set “EMLMR links” to receive an initial frame transmitted by the AP MLD to initiate frame exchange and next to perform data frame exchange with the AP MLD over only one EMLMR link (aggregating the radio resources) at a time, usually the link over which the initial frame is received.

The description below mostly concentrates on the EMLSR mode for ease of explanation. However, similar considerations can be made with respect to the EMLMR mode.

FIG. 1 illustrates a typical 802.11 network environment involving ML transmissions between EML-capable MLDs (EMLSR and or EMLMR capable) in which the present invention may be implemented.

Wireless communication network 100 involves an AP MLD 110 and two non-AP MLDs 120 and 130. In the example, the two non-AP MLDs are considered to be EML capable and have declared their corresponding capabilities to the AP MLD 110, within the EMLSR-related fields and EMLMR-related fields of the EML Capabilities (these fields are referred to below as EMLSR Capabilities and EMLMR Capabilities, i.e., subparts of the EML Capabilities). Of course, another number of non-AP MLDs registering to the AP MLD 110 and then exchanging frames with it may be contemplated, as well as another (greater) number of EML-capable non-AP MLDs.

AP MLD 110 has multiple affiliated APs, two affiliated APs 111 and 112 (also referenced AP1, AP2 respectively) in the exemplary FIG. 1, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

The non-AP MLDs 120, 130 have multiple affiliated non-AP STAs, each of which behaves as an 802.11 non-AP STA in a BSS (managed by an affiliated AP 111 or 112) to which it registers.

In the exemplary FIG. 1, two non-AP STAs 121 and 122 (also referenced A1 and A2 respectively) are affiliated with non-AP MLD 120 and two non-AP STAs 131 and 132 (also referenced B1 and B2 respectively) are affiliated with non-AP MLD 130.

For illustrative purposes, non-AP MLDs 120 and 130 are single-radio non-AP MLDs. For example, AP 111 is set to operate on channel 38 corresponding to an operating 40 MHz channel in the 5 GHz frequency band and AP 112 is set to operate on channel 151 corresponding to another operating 40 MHz channel in the 5 GHz frequency band too. In another example, the affiliated STAs could operate on different frequency bands.

Each affiliated AP offers a link towards the AP MLD 110 to the affiliated non-AP STAs of a non-AP MLD (120 or 130). Hence, the links for each non-AP MLD can be merely identified with the identifiers of the respective affiliated APs. In this context, each of the affiliated APs 111 and 112 can be identified by an identifier referred to as “link ID”. The link ID of each affiliated AP is unique and does not change during the lifetime of the AP MLD. AP MLD may assign the link ID to its affiliated APs by incrementing the IDs from 0 (for the first affiliated AP). Of course, other wording, such as “AP ID”, could be used in a variant.

To perform multi-link communications, each non-AP MLD 120, 130 has to discover, authenticate, associate and set up multiple links with the AP MLD 110, each link being established between an affiliated AP of the AP MLD 110 and an affiliated non-AP STA of the non-AP MLD. Each of such links, referred to as “enabled link” enables individual channel access and frame exchanges between the non-AP MLD and the AP MLD based on supported capabilities exchanged during association.

The discovery phase is referred below to as ML discovery procedure, and the multi-link setup phase (or association phase) is referred below to as ML setup procedure.

The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information, e.g. including all or part of capabilities and operation parameters. Once a non-AP MLD has discovered the wireless communication network 100 through the ML discovery procedure and after an MLD authentication procedure, the ML setup procedure allows it to select a set of candidate setup links between its own affiliated non-AP STAs and some of the discovered affiliated APs and to request the AP MLD 110 to set up these links, which may be accepted or refused by the AP MLD. If the AP MLD accepts, the non-AP MLD is provided with an Association Identifier (AID) by the AP MLD, which AID is used by the affiliated non-APs of the non-AP MLD to wirelessly communicate over the multiple links (communication channels) with their corresponding affiliated APs. During the ML setup procedure, the non-AP MLDs declare part or all of their capabilities. For instance, they may declare their EMLSR capability. For this, appropriate fields are provided in the management frames. In particular, some of the management frames exchanged during the ML discovery and ML setup procedures contains a new Information Elements specific to the Multi-Link Operation (MLO), referred to as Basic Multi-Link element. De facto, in all Management frames that include a Basic Multi-Link element except Authentication frames, a non-AP or AP MLD which is EMLSR capable (dot11EHTEMLSROptionImplemented equal to true) or EMLMR capable (dot11EHTEMLMROptionImplemented equal to true) sets, in the EML Capabilities subfield of the Common Info field, the EMLSR or EMLMR Support bit to 1.

For illustrative purpose, in wireless communication network 100, during the ML setup procedures, two candidate setup links have been requested by non-AP MLD 120 and accepted by AP MLD 110: a first link 151 between affiliated AP 111 (AP1) and affiliated non-AP STA 121 (A1), a second link 152 between affiliated AP 112 (AP2) and affiliated non-AP STA 122 (A2). Similarly, two candidate setup links have been requested by multi-radio non-AP MLD 130 and accepted by AP MLD 110: a first link 161 between affiliated AP 111 (AP1) and affiliated non-AP STA 131 (B1), a second link 162 between affiliated AP 112 (AP2) and affiliated non-AP STA 132 (B2).

AP MLD 110, non-AP MLD 120 and non-AP MLD 130 are considered as EMLSR capable (dot11EHTEMLSROptionImplemented equal to true) or EMLMR capable (dot11EHTEMLMROptionImplemented equal to true). They exchange their EMLSR or EMLMR capabilities (subparts of the EML Capabilities) during their ML discovery procedure and the multi-link setup phase.

As currently defined in the D1.5 Standard, the EMLSR and EMLMR Capabilities include the following subfields:
the “EMLSR Support” subfield indicating support of the EMLSR operation for the MLD. The EMLSR Support subfield is set to 1 if the MLD supports the EMLSR operation; otherwise it is set to 0;
the “EMLSR Padding Delay” 3-bit subfield indicating the minimum MAC padding duration of the Padding field of the initial Control frame requested by the non-AP MLD as defined in the Enhanced multi-link single radio operation (section 35.3.17). A table converts the 3-bit values into padding delays in us. This delay is used to define the transition period needed by the MLD to switch the state of its affiliated stations from the listening operation state to the enable/disable frame exchange states. This transition period is made of this delay added to the time length of an Initial Control frame response or Initial frame response as described below. This transition period is therefore referred to as “EMLSR active switch delay” or “EMLMR active switch delay” depending on the EML mode active, and more generally to “EML active switch delay” below;
the “EMLSR Transition Delay” 3-bit subfield indicating the transition delay time needed by a non-AP MLD to switch from so-called frame exchange modes (on one of the enabled links) to the so-called listening operation mode on the enabled links. A table converts the 3-bit values into delays in us. For instance, it is set to 0 for 0 μs, set to 1 for 16 μs, 2 for 32 μs, set to 3 for 64 μs, set to 4 for 128 μs, set to 5 for 256 μs, and the values 6 to 7 are reserved;
the “EMLMR Support” subfield indicating support of the EMLMR operation for the MLD. The EMLMR Support subfield is set to 1 if the MLD supports the EMLMR operation; otherwise it is set to 0;
the “EMLMR Delay” 3-bit subfield indicating the minimum padding duration required for a non-AP MLD for EMLMR link switch when operating in the EMLMR mode. This delay is used to define the transition periods needed by the MLD to switch the state of its affiliated stations when starting or ending a frame exchange;
the “Transition Timeout” subfield indicating the timeout value for EML Operating Mode Notification frame exchange in EMLSR (or EMLMR).

When a non-AP MLD which is EMLSR (resp. EMLMR) capable intends to operate in the corresponding mode on a set of enabled links, referred to as EMLSR (resp. EMLMR) links, a STA affiliated with the non-AP MLD transmits an EML Operating Mode (OM) Notification frame (specified in D1.5 standard) with the EMLSR (resp. EMLMR) Mode subfield of the EML Control field set to 1 to an AP affiliated with an AP MLD which is EMLSR (resp. EMLMR) capable (here AP MLD 110). The EMLSR (resp. EMLMR) links are indicated in the EMLSR (resp. EMLMR) Link Bitmap subfield of the EML Control field of the EML OM Notification frame by setting the bit positions of the EMLSR (resp. EMLMR) Link Bitmap subfield to 1 for each of the EMLSR (resp. EMLMR) links. For example, in the EMLSR (resp. EMLMR) Bitmap, the bit position i corresponds to the link with the Link ID equal to i and is set to 1 to indicate that the link is a member of the EMLSR (resp. EMLMR) links.

The AP affiliated with the AP MLD that received the EML Operating Mode Notification frame from the STA affiliated with the non-AP MLD next transmits an EML Operating Mode Notification frame to one of the STAs affiliated with the non-AP MLD within the timeout interval indicated in the Transition Timeout subfield in the EML Capabilities subfield of the Basic Multi-Link element starting at the end of the PPDU transmitted by the AP affiliated with the AP MLD as an acknowledgement to the EML Operating Mode Notification frame transmitted by the STA affiliated with the non-AP MLD.

After the successful transmission of the EML Operating Mode Notification frame on one of the EMLSR (resp. EMLMR) links by the STA affiliated with the non-AP MLD, the non-AP MLD operates in the EMLSR (resp. EMLMR) mode, it is considered as EMLSR-active (resp. EMLMR-active).

When a non-AP MLD which is EMLSR capable intends to disable the EMLSR (resp. EMLMR) mode, a STA affiliated with the non-AP MLD transmits an EML Operating Mode (OM) Notification frame (specified in D1.5 standard) with the EMLSR (resp. EMLMR) Mode subfield of the EML Control field set to 0 to an AP affiliated with the AP MLD. Again, an AP affiliated with the AP MLD that received the EML Operating Mode Notification frame from the STA affiliated with the non-AP MLD transmits an EML Operating Mode Notification frame as above as an acknowledgement to the EML Operating Mode Notification frame. After the successful transmission of the EML Operating Mode Notification frame on one of the EMLSR (resp. EMLMR) links by the STA affiliated with the non-AP MLD, the non-AP MLD disables the EMLSR (resp. EMLMR) mode.

The set of STAs affiliated with an EMLSR (resp. EMLMR) capable non-AP MLD operating on the EMLSR (resp. EMLMR) links may be all or part of the STAs affiliated with the non-AP MLD. The STAs of this set are referred below to “EMLSR co-affiliated STAs” (resp. EMLMR co-affiliated STAs) for the non-AP MLD.

In the example of FIG. 1, the EMLSR co-affiliated STAs of non-AP MLD 120 and of non-AP MLD 130 operate on the same links (i.e., with the same affiliated APs, AP1 and AP2) meaning they share the same EMLSR links.

FIG. 1a illustrates an exemplary 802.11be multi-link reference model for a MLD either AP MLD or non-AP MLD.

The MLD comprises a PHY layer 200, a MAC layer 220, a logical link control (LLC) sublayer and upper layers.

Upper layers may include applications that generate traffic data or use received traffic data.

The transmission and the reception of the traffic data are handled by the MAC 220 and PHY 200 layers. Such transmission and reception of the traffic data may take place over multiple links 20-x, 20-y, 20-z, as the ones 151, 152, 161, 162 introduced with reference to FIG. 1. Three links and therefore three affiliated stations are shown. Of course, other configurations including two affiliated stations or more than three affiliated stations may be contemplated.

The traffic data are provided by the upper layers as a sequence of data frames, or “traffic stream”. Each traffic stream and thus each data frame are associated with an access category (AC) as defined in the EDCA mechanism (FIG. 1b). This mapping between the streams or data frames and the ACs is made by a classifier 213.

It is recalled that an 802.11 station (AP and non-AP station) maintains four Access Categories (ACs), each having one or more corresponding transmit buffers or queues. The four ACs are conventionally defined as follows:
AC1 and AC0 are reserved for best effort and background traffic. They have, respectively, the penultimate lowest priority and the lowest priority.
AC3 and AC2 are usually reserved for real-time applications (e.g., voice or video transmission). They have, respectively, the highest priority and the penultimate highest priority.

The data frames, also known as MAC service data units (MSDUs), incoming from an upper layer of the protocol stack are mapped, by classifier 213, onto one of the four ACs and thus input in a queue of the mapped AC.

FIG. 1b illustrates an implementation model with four transmit queues, one per access category.

The 802.11be multi-link reference model reflects the fact that MLDs may transmit and receive using several links, particularly at the level of the MAC layer 220 and the PHY layer 200. The MAC layer 220 comprises one Unified Upper-MAC (UMAC) layer 230, multiple Lower-MAC (LMAC) layers 220-x, 220-y, 220-z coupled with a respective PHY layer 200-x, 200-y, 200-z, each couple corresponding to a link 20-x, 20-y, 20-z.

The UMAC 230 performs functionalities that are common across all links and each LMAC 220-x, 220-y, 220-z performs functionalities that are local to each link 20-x, 20-y, 20-z. The UMAC layer then offers a UMAC interface with the link-specific blocks 220-x, 220-y, 220-z and also provides a UMAC Service Access Point (SAP) to the LLC and upper layers.

The UMAC 230 is responsible for link-agnostic MAC procedures such as authentication, association, security association, sequence number assignments, MAC Protocol Data Unit (MPDU) encryption/decryption, aggregation/de-aggregation, acknowledgement score boarding procedure, etc.

Each data unit, MSDU, arriving at the MAC layer 220 from an upper layer (e.g. Link layer) with a type of traffic (User Priority (UP), hence Traffic IDentifer (TID)) priority is mapped onto one of the ACs according to the mapping rule at the UMAC layer 230. Then, still at the UMAC layer 230, the data unit, MSDU, is provided with the next sequence number available and is stored in the queue corresponding to its TID (or UP) within the mapped AC. It is recalled that an 802.11 station maps the TIDs onto ACs as follows (TIDx refers to TID=x):
TID1 and TID2 are mapped onto AC0 used typically for background traffic,
TID0 and TID3 are mapped onto AC1 used typically for best effort traffic,
TID4 and TID5 are mapped onto AC2 used typically for video traffic,
TID6 and TID7 are mapped onto AC3 used typically for voice traffic.

Each LMAC 220-x, 220-y, 220-z is in charge of link specific functionalities, as the channel access. In particular, each MLD Lower MAC includes its own contention-based channel access procedure, e.g., EDCA 221-x, 221-y, 221-z. Some of the functionalities require joint processing of both the UMAC 230 and LMACs 220-x, 220-y, 220-z.

As illustrated in FIGS. 1a and 1b, each EDCA 221-x, 221-y, 221-z per link performs contention per link for each AC queue. In that respect, each AC has its own set of queue contention parameters (i.e., EDCA access parameters) per link, and is associated with a priority value, hence defining traffics of higher or lower priority of MSDUs. Thus, there is a plurality of traffic queues for serving data traffic at different priorities for a given link. The arbitration inter-frame space (AIFSn), the contention window (CW) and the backoff values are known as being EDCA access parameters, and are specialized for each AC on each link 20-x, 20-y, 20-z.

It is reported in the table below the default EDCA access parameters for an 802.11 station:

| Access Category | AISFn | CWmin | CWmax | TXOP limit |
|---|---|---|---|---|
| AC0 | AIFS0 = 7 | 31 | 1023 | 0 |
| AC1 | AIFS1 = 3 | 31 | 1023 | 0 |
| AC2 | AIFS2 = 2 | 15 | 31 | 3,008 ms |
| AC3 | AIFS3 = 2 | 7 | 15 | 1,504 ms |

It is also recalled that, for an 802.11 station, the backoff value is selected randomly from the range [0, CW], where CW is typically initialized with the value of CWmin. This backoff value is used to initialize the backoff counter (BC). During the backoff procedure, if the medium is sensed as idle for a given slot time (9 μs, typically), the backoff counter is decremented by 1; if the medium is sensed as busy during a given slot time, the backoff counter is suspended.

It is also recalled that the IEEE Std 802.11ax™-2021 has introduced, in addition to the EDCA parameters set, the Multi User (MU) EDCA parameters set. As an 802.11ax station can transmit UL data using both EDCA contention-based transmission and Trigger-Based transmission, it has more medium access opportunities than a legacy 802.11 station. Therefore, to ensure fairness, the IEEE Std 802.11ax™-2021 has introduced the MU EDCA mechanism which de-prioritizes an 802.11ax station after a Trigger-based UL transmission, for a time period specified in the so-called MUEDCATimer (one per AC), using the (less favourable) MU EDCA parameters set instead of the legacy EDCA parameters set. The use of MU EDCA parameters set usually results in a longer time period of contention and backoff. An AP signals the legacy EDCA parameter set and the MU EDCA parameter set in its broadcast Beacon frames and/or in the association response frames exchanged with the non-AP STAS.

For an MLD, each AC or traffic queue 210 is mapped onto one EDCA engine 221 per link. Thus, each backoff entity 211 of an EDCA engine 221 dedicated to a link is associated with a respective AC queue 210 for using queue contention parameters and drawing a backoff value to initialize a respective queue backoff counter (BC) specialized per AC and per link. In FIG. 1b, backoff counters BC[x0], BC[x1], BC[x2], BC[x3] are respectively associated with traffic queues 210 of AC0, AC1, AC2, AC3 and will be used, concurrently, to contend for access to link 20-x. Similarly, backoff counters BC[y0], BC[y1], BC[y2], BC[y3] are respectively associated with traffic queues 210 of AC0, AC1, AC2, AC3 and will be used, concurrently, to contend for access to link 20-y. Similarly, backoff counters BC[z0], BC[z1], BC[z2], BC[z3] are respectively associated with traffic queues 210 of AC0, AC1, AC2, AC3 and will be used, concurrently, to contend for access to link 20-z. Here, the numbering proposed to easily identify a backoff counter is BC[Link, AC]. As an example, BC[z2] identifies the backoff counter corresponding to Link 20-z and AC2. Then, one can notice that in an MLD, the number of backoff counters is typically equal to Number of ACs x Number of Links. In the example of FIG. 1b, the number of backoff counters is 4×3=12.

However, it has to be pointed out that this number is the maximum possible number of backoff counters. It is obtained when the default TID-To-Link mapping is used for the MLD. Together with the Multi-Link Operation, the D1.5 standard defines the TID-To-Link mapping mechanism which allows an AP MLD and a non-AP MLD that performed or are performing multi-link setup to determine how UL and DL QoS traffic corresponding to TID values between 0 and 7 are assigned to the setup links for the non-AP MLD. By default, all TIDs are mapped onto all setup links for both DL and UL, and all setup links are enabled. As a result, when the default TID-To-Link mapping is used, the maximum number of backoff counters is actually implemented. However, when the TID-To-Link mapping is negotiated between the AP MLD and the non-AP MLD to map some TIDs to a set of links and some other TIDs to another set of links, the number of backoff counters is mechanically lower. As an example, considering a negotiated TID-To-Link mapping that maps TIDs 4 and 5 belonging to AC2 to Link 20-x only, only BC[x2] is to be used while BC[y2] and BC[z2] will no longer be used in this case.

In the rest of this description, unless clearly indicated, the use of the default TID-To-Link mapping is considered.

A backoff counter is used to contend for access to the link 20-x, 20-y or 20-z in order to transmit data stored in the queue of the AC. Practically, the backoff counter is decremented from its initialization value when the medium is idle, and the corresponding affiliated STA 201-x, 201-z is allowed to transmit (access granted) when the backoff counter reaches 0. One understands that the TID-To-Link mapping (be it negotiated or by default) has an impact on the number of BCs that are simultaneously decremented at the non-AP MLD to drive EDCA access to each link.

When the access to the wireless medium is granted for an AC on a given link, MSDUs stored in the traffic queue 210 corresponding to that AC are transmitted to the physical (PHY) layer 200-x, 200-y, 200-z for transmission over the given link.

In the case of an MLD being Multi-Radio and able to Simultaneous Transmission and Reception (STR), each affiliated STA operates on a link independently of other affiliated STAs operating on other links.

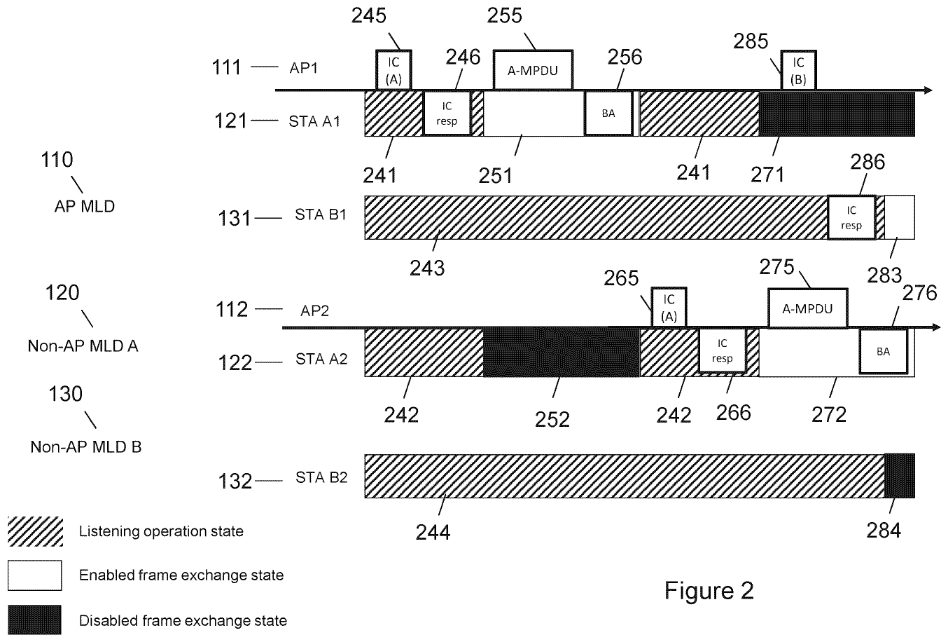

FIG. 2 illustrates, using a frames sequence, the EMLSR Operating Mode in non-AP MLD 120 when AP MLD 110 decides to use the EMLSR mode. Of course, although the EMLSR mode is emphasized here by way of example, similar considerations can be made with respect to the EMLMR mode.

In this sequence, the non-AP MLDs operate in the EMLSR mode, meaning EML Operating Mode Notification frames activating the EMLSR mode have been successfully transmitted by affiliated STAs of the non-AP MLD 120. In other words, it has entered an active Enhanced Multi-Link Single Radio, EMLSR, mode applying to a specific set of two or more enabled links.

The affiliated STAs 121 and 122 are EMLSR co-affiliated STAs within non-AP MLD 120. Each affiliated STA can be in one of three defined states: listening operation state, enabled frame exchange state and disabled frame exchange state.

Non-AP MLD 120 is able to listen simultaneously on its EMLSR links, by having its EMLSR co-affiliated STA(s) corresponding to those links in “awake” or “listening operation” state. For example, affiliated STAs A1, A2 are in the listening operation state (referenced 241 and 242). The listening operation includes CCA (Clear Channel Assessment) and receiving an initial Control frame of frame exchanges that is initiated by the AP MLD. In non-AP MLD 120, the two EMLSR co-affiliated STAs therefore simultaneously listen for receiving the initial Control frame from the AP MLD.

When the AP MLD 110 intends to initiate frame exchanges with one or more non-AP MLDs on one of the EMLSR links, it begins the frame exchanges by transmitting the initial Control frame 245 which explicitly triggers the non-AP MLD. To a certain extent, the initial Control frame schedule the non-AP MLD. The initial Control frame of frame exchanges is sent in the OFDM PPDU or non-HT duplicate PPDU format using a rate of 6 Mbps, 12 Mbps, or 24 Mbps (i.e. MCS subfield in the frame set to a value up to 2). As defined in the D1.5 Standard, the initial Control frame shall be a MU-RTS Trigger frame or a BSRP Trigger frame as defined in IEEE Std 802.11ax™-2021. Given the trigger frame format according to which such a frame includes one or more User Info fields, this condition means frame 245 includes a User Info field addressed to the non-AP MLD, i.e., where an AID12 field is set to the AID of the non-AP MLD (obtained upon registration).

In the present example and as shown by reference “IC (A)”, the initial Control frame 245 explicitly triggers non-AP MLD A 120. The initial Control frame may explicitly trigger multiple non-AP MLDs using multiple User Info fields therein.

The EMLSR co-affiliated STA of the non-AP MLD explicitly triggered by the initial Control frame 245 that receives the frame, e.g., affiliated STA A1 in the example, initiates a state change of the EMLSR co-affiliated STA of the non-AP MLD considered, e.g., a change of the states of affiliated STAs A1 and A2 in the example, and sends an Initial Control frame response (IC resp.) 246 to the AP AP1 affiliated with the AP MLD 110.

After receiving the initial Control frame of frame exchanges 245 and transmitting an immediate response frame 246 as a response to the initial Control frame, the STA affiliated with the non-AP MLD that was listening on the corresponding link, i.e., the receiving EMLSR co-affiliated STA A1 in the example, is configured to be able to transmit or receive frames on the enabled link in which the initial Control frame 245 was received, i.e., link 151 in the example. To do so, a state switching procedure is invoked upon receiving frame 245, which results in having the receiving EMLSR co-affiliated STA being switched, after an EMLSR active switch delay, from the listening operation state 241 to an “active frame exchange” or “enabled frame exchange” state, referenced 251 in the Figure. The receiving EMLSR co-affiliated STA in this new state is capable of receiving a PPDU that is sent using more than one spatial stream on the link in which the initial Control frame 245 was received. The EMLSR active switch delay corresponds to the delay time needed by a non-AP MLD to switch from the EMLSR listening operation mode to the EMLSR frame exchange mode. As mentioned above, it derives from indication specified in the EML Capabilities (through the EMLSR Padding Delay) exchanged with the AP MLD: it is the EMLSR Padding Delay added to the time length of Initial Control frame response 246.

Simultaneously, the other EMLSR co-affiliated STAs of the same non-AP MLD, i.e. STA A2 in the example, are configured not to transmit or receive on the other EMLSR link(s) until the end of the frame exchanges. To do so, a state switching procedure is also invoked for the other EMLSR co-affiliated STAs which in turn are switched from the listening operation state 242 to a “blindness frame” or “disabled frame exchange” state, referenced 252 in the Figure. In particular, no data is transmitted by the AP MLD intended to these other EMLSR co-affiliated STAs.

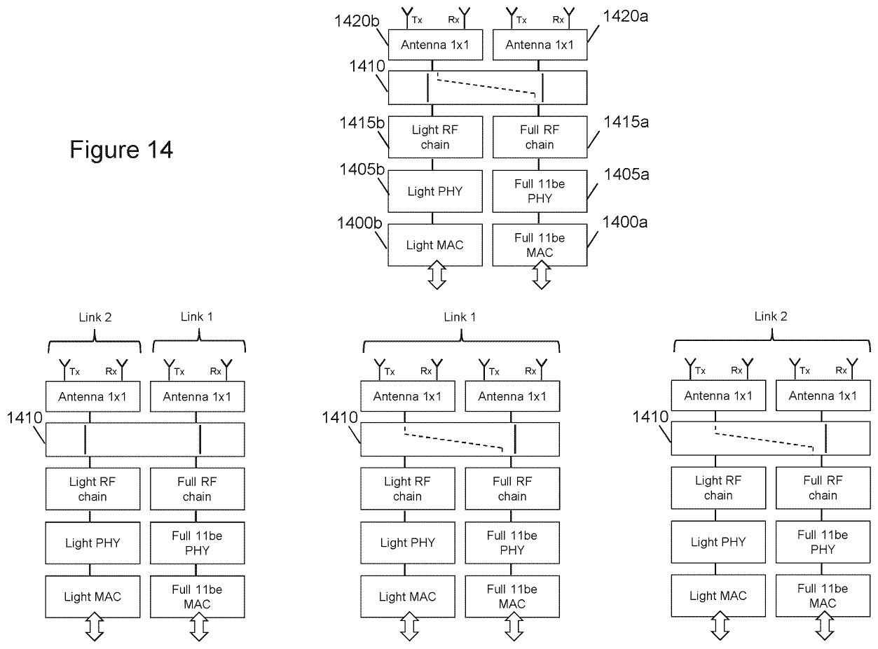

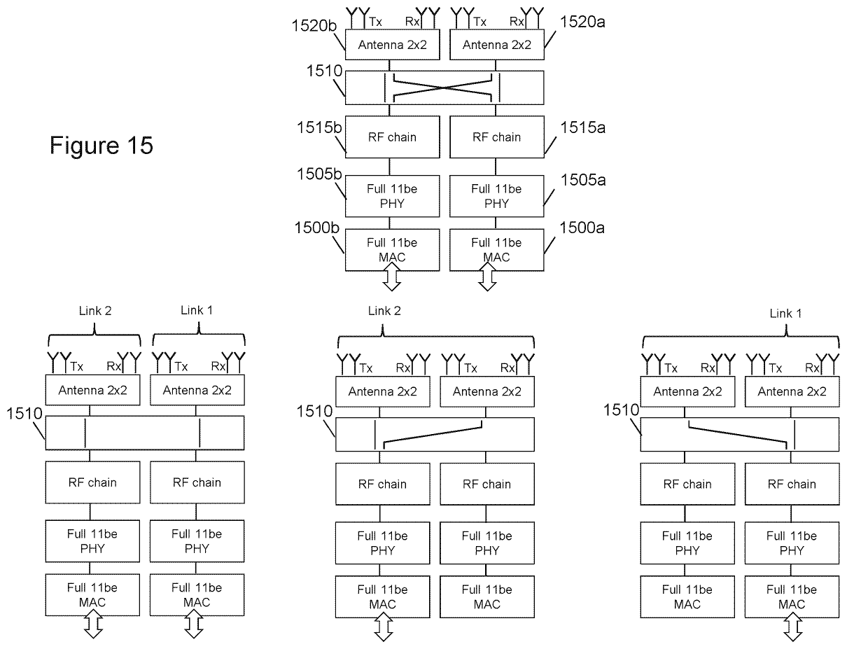

The state switches of all the EMLSR co-affiliated STAs within the same non-AP MLD are inseparable, hence simultaneous, because it is a question of allocating a full radio resource chain (see FIG. 14 below) to one of the STAs while the others are deprived of such chain. With respect to the EMLMR mode, the physical resources (e.g., antennas) of one radio resource chain are allocated (and aggregated) to the other radio resource chain, the former being therefore deprived of transmission/reception capabilities (see FIG. 15 below).

The above shows that when a non-AP MLD operates in the EMLSR mode (and more generally in any of the EMLSR and EMLMR mode), it is either in a listening operation mode (its co-affiliated STAs are in the listening operation state) or in a frame exchange mode (one of its co-affiliated STAs is in the enabled frame exchange state while the other co-affiliated STAs are in the disabled frame exchange state).

The simultaneous state change is required because, in the EMLSR mode, a single full radio resource is available that is assigned to the receiving EMLSR co-affiliated STA only, as explained below with reference to FIG. 14, while in the EMLMR mode, the antenna resources of one of the radio stack are assigned to the other radio stack as explained below with reference to FIG. 15.

It turns out that only one of the EMLSR co-affiliated STAs of an explicitly triggered non-AP MLD can perform data frames exchange at a time with the AP MLD; this is usually the EMLSR co-affiliated STAs which received the initial Control frame 245.

An exemplary frame exchange sequence is shown in the Figure that includes the sending of an A-MPDU frame 255 (hence downlink transmission) by the affiliated AP AP1 to the EMLSR co-affiliated STA A1 of explicitly triggered non-AP MLD A 120, followed by a corresponding block acknowledgment 256 from the latter.

After the end of the frame exchanges operated by the receiving EMLSR co-affiliated STA plus an EMLSR Transition Delay as specified in the EML capabilities, the non-AP MLD 120 switches back to the EMLSR listening operation state, meaning that the receiving EMLSR co-affiliated STA A1 switches back to the listening operation state 241 as well as the other EMLSR co-affiliated STA A2 (listening operation state 242). A state switching procedure is therefore invoked for each of the EMLSR co-affiliated STAs.

An end of frame exchanges can be sensed by a non-AP MLD, here non-AP MLD 120, if one of the following conditions is met:

(1) The MAC of the STA affiliated with the non-AP MLD that received the initial Control frame 245 does not receive a PHY-RXSTART.indication primitive during a timeout interval of aSIFSTime+aSlotTime+aRxPHYStartDelay starting at the end of the PPDU (e.g. acknowledgment 256) transmitted by the STA of the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement. This represents the end of an actual exchange with the AP MLD, without receiving a subsequent frame from the latter.

(2) The MAC of the STA affiliated with the non-AP MLD that received the initial Control frame 245 receives a PHY-RXSTART.indication primitive during a timeout interval of aSIFSTime+aSlotTime+aRxPHYStartDelay starting at the end of the PPDU (e.g. acknowledgment 256) transmitted by the STA of the non-AP MLD as a response to the most recently received frame (e.g. A-MPDU frame 255) from the AP affiliated with the AP MLD or starting at the end of the reception of the PPDU containing a frame for the STA from the AP affiliated with the AP MLD that does not require immediate acknowledgement, and the STA affiliated with the non-AP MLD does not detect, within the PPDU corresponding to the PHY-RXSTART.indication any of the following frames:
an individually addressed frame with the RA equal to the MAC address of the STA affiliated with the non-AP MLD,
a Trigger frame that has one of the User Info fields addressed to the STA affiliated with the non-AP MLD,
a CTS-to-self frame with the RA equal to the MAC address of the AP affiliated with the AP MLD,
a Multi-STA BlockAck frame that has one of the Per AID TID Info fields addressed to the STA affiliated with the non-AP MLD,
a NDP Announcement frame that has one of the STA Info fields addressed to the STA affiliated with the non-AP MLD.

This corresponds to the case where, after an actual exchange with the AP MLD, the non-AP MLD receives another frame from the AP MLD which is not addressed to it (i.e. no data is addressed to it or no resource is allocated to it).

(3) The STA affiliated with the non-AP MLD that received the initial Control frame 245 does not respond to the most recently received frame (e.g., A-MPDU frame 255) from the AP affiliated with the AP MLD that requires immediate response after a SIFS.

As non-AP MLD 120 is now in the EMLSR listening operation mode, the AP MLD may initiate any new frame exchange sequence (with either of non-AP MLD 120 or 130) by transmitting a new initial Control frame.

In the example of the Figure, the AP MLD 110 decides to initiate such a new sequence with non-AP MLD 120 again, using its EMLSR co-affiliated STA A2 122. In details, the AP MLD 110 using its other affiliated AP 112 transmits a new Initial Control frame 265 IC (A) explicitly triggering the non-AP MLD A 120, which frame is now received by the EMLSR co-affiliated STA A2 122. The receiving EMLSR co-affiliated STA A2 122 transmits a response frame 266 to the Initial Control frame 265. After an EMLSR active switch delay, the explicitly triggered non-AP MLD 120 switches to EMLSR frame exchange mode where the receiving EMLSR co-affiliated STA A2 122 switches from the listening operation state 242 to the enabled frame exchange state 272 while its other EMLSR co-affiliated STA A1 121 simultaneously switches from the listening operation state 241 to the disabled frame exchange state 271. Frames 275, 276 are then exchanged during the frame exchange sequence, up to the end of the sequence where the non-AP MLD 120 switches back to the EMLSR listening operation mode.

A-MPDU 255/275 is only provided as an illustration. Other types of frames can be sent by the AP MLD, e.g., basic Trigger frames to trigger UL transmissions. Although FIG. 2 shows frame exchanges made of a single frame 255/275 followed by an acknowledgment 256/276, simpler frame exchanges may only comprise a single frame sent by the AP MLD without acknowledgment, while more complex frame exchanges may comprise multiple sequences of exchanges, e.g., cascaded TXOPs for UL transmissions (triggered by a basic Trigger frame) and/or for DL transmissions (through an HE MU PPDU).

This illustrative example shows the advantages of the EMLSR mode in terms of throughput and latency: the AP MLD may switch quickly from one link to another link, hence improving communication performances for a limited increase of complexity and cost.

In this example, the AP MLD 110 initiates the sequence of frame exchange with one or more designated non-AP MLDs. The D1.5 standard also allows the non-AP MLDs to initiate a sequence of frame exchange with the AP MLD. In other words, a STA affiliated with a non-AP MLD operating in the EMLSR mode does not need to transmit an initial Control frame to initiate frame exchanges with the AP MLD. Such affiliated STA follows the rules defined in sections 10.3.2.4 (to set and reset the NAV) and 10.23.2 (HCF contention based channel access (EDCA)) to access the wireless medium.

However, conventional contention based channel access is not defined with respect to the particularities of EMLSR-active MLDs, in particular regarding the states of their co-affiliated STAs. It is recalled that an EMLSR-capable non-AP MLD becomes EMLSR-active following a successfully exchange of an EML OM Notification frame with the EMLSR-capable AP MLD, in which frame the EMLSR Mode subfield of the EML Control field is set to 1 and the EMLSR links are specified, hence the corresponding EMLSR co-affiliated STAs.

As mentioned above, the preceding description also applies to the EMLMR mode with, inter alia, the following matchings: the EMLMR Delay applies for both EMLSR Padding Delay and EMLSR Transition Delay; the initial frame in the EMLMR mode matches the initial control frame in the EMLSR mode and similarly the initial frame response in the EMLMR mode matches the initial control frame response in the EMLSR mode; although not defined in the D1.5 Standard, an EMLMR listening operation state/mode can be defined that matches the EMLSR listening operation state/mode where the co-affiliated STAs are listening to their links before aggregation of physical radio resources.

Embodiments of the invention seek to arrange the EDCA procedure to match with EMLSR or EMLMR particularities of the co-affiliated STAs being in one of the EML modes.

In first embodiments, the initiation of the frame exchange by a “first” EMLSR or EMLMR co-affiliated STA includes:
first switching the first co-affiliated STA from its listening operation state to an enabled frame exchange state,
before invoking, by the same first co-affiliated STA in the enabled frame exchange state, an enhanced distributed channel access, EDCA, backoff procedure decrementing a backoff counter, to access the first link.

In these embodiments, the EML-active non-AP MLD change its operation mode into the EML frame exchange mode before starting contention on the wireless medium by decrementing its backoff counter or counters. As a consequence, the state switch delay (EMLSR active switch delay or EMLMR active switch delay) is not likely to impact the contention procedure by the co-affiliated STA, in particular to create risks that an access to the medium be gained by another MLD after the contention ends but the STA has not yet finished switching its state to transmit its first frame.

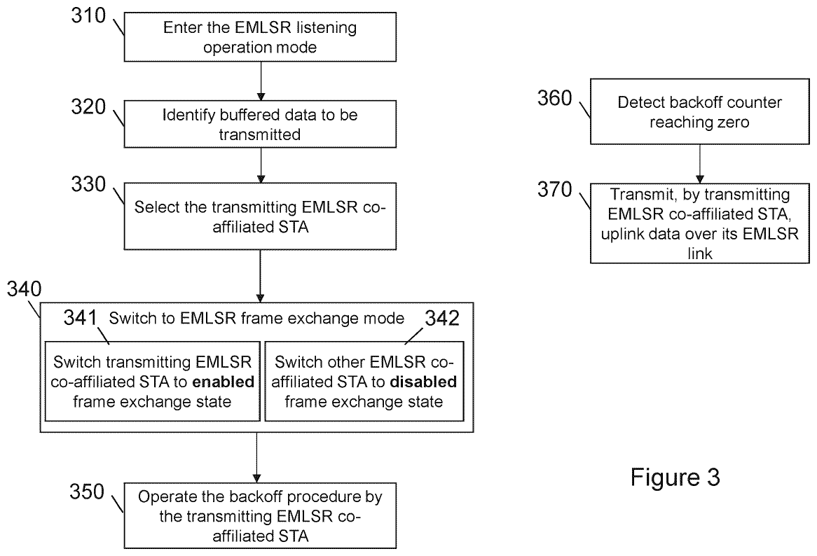

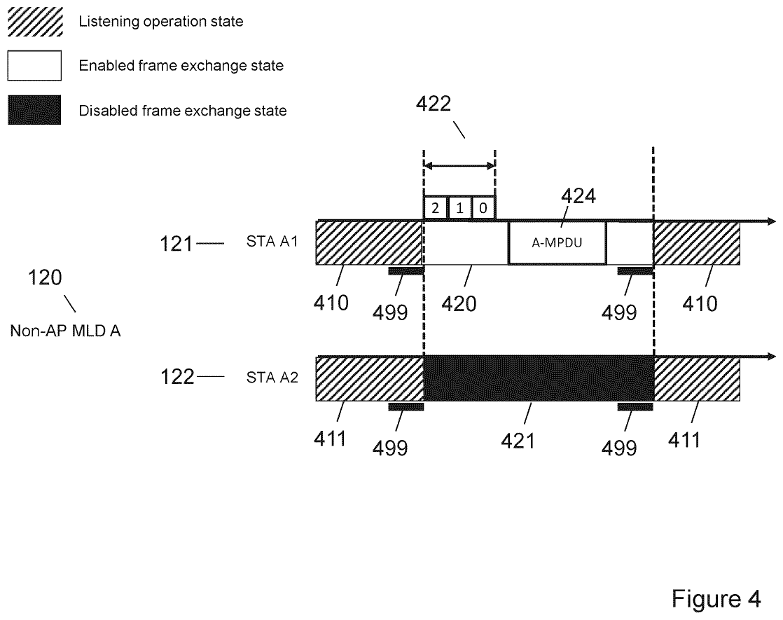

These first embodiments are illustrated by FIGS. 3 and 4 which emphasize the EMLSR mode by way of example. The same mechanisms apply to the EMLMR mode given the words matching mentioned above.

FIG. 3 illustrates, using flowcharts, steps performed by an EMLSR-active non-AP MLD to operate a first contention-based channel access procedure, according to the first embodiments. FIG. 4 schematically illustrates an exemplary timeline of the first contention-based channel access procedure as described in FIG. 3.

The process starts at step 310 where the non-AP MLD enters the EMLSR listening operation mode, meaning its EMLSR co-affiliated STAs are set in the listening operation state, hence they are simultaneously listening to their respective EMLSR links. The non-AP MLD may enter the EMLSR listening operation mode as a response to receiving an EML OM Notification frame with its EMLSR Mode subfield (in the EML Control field) set to 1. In a variant, the non-AP MLD may enter the EMLSR listening operation mode by switching back from the EMLSR frame exchange mode.

As shown with EMLSR-active non-AP MLD 120 in the EMLSR listening operation mode in FIG. 4, both EMLSR co-affiliated STAs A1 121 and A2 122 are both in the listening operation state 410 and 411.

At step 320, the non-AP MLD waits until it has buffered uplink data to be transmitted to AP MLD 110. As mentioned above, such data may be provided by upper layers and stored in the buffers 210 of the non-AP MLD.

When such data have been identified, the non-AP MLD seeks to invoke a contention-based channel access procedure to access one of its EMLSR links and transmit its buffered data.

To do so, it selects, at step 330, one of its EMLSR co-affiliated STA on which it will operate the contention-based channel access procedure. The selected STA is referred to as transmitting EMLSR co-affiliated STA and the corresponding link is referred to as transmitting EMLSR link.

Any selection procedure can be used. For example, it may rely on a round-robin strategy or a random strategy or a load-balancing strategy based on the links occupancy (in such a case, the EMLSR link with the less occupation rate is preferably selected) or a radio-based strategy (in such a case, the EMLSR co-affiliated STA having the current full radio may be preferably selected).

In the example of FIG. 4, EMLSR co-affiliated STA 1 is selected. It may indifferently be the station having the full radio or having the light (reduced function) radio.

Next, at step 340, a state switching procedure is invoked by the non-AP MLD to switch its mode from the EMLSR listening operation mode to the EMLSR frame exchange mode, where the transmitting EMLSR co-affiliated STA is put into the enabled frame exchange state.

For this, the transmitting EMLSR co-affiliated STA is switched (step 341) from the listening operation state to the enabled frame exchange state, while in parallel (synchronously or simultaneously), the other EMLSR co-affiliated STA is switched (step 342) from the listening operation state to the disabled frame exchange state.

In some embodiments, step 340 is conditional to detecting the corresponding link is idle through CCA validation. It means the transmitting EMLSR co-affiliated STA performs CCA during its switch or just before triggering the switch in order to be sure the link is idle, hence ready for an EDCA backoff procedure. In these embodiments, the transmitting EMLSR co-affiliated STA starts or performs the switch only if the corresponding link is detected as idle.

In FIG. 4, when non-AP MLD 120 desires to initiate a frame exchange sequence with AP MLD 110 to transmit its buffered data and has selected EMLSR co-affiliated STA A1 121 as transmitting EMLSR co-affiliated STA, it switches (possibly after CCA validation) the latter (A1 121) from the listening operation state 410 to the enabled frame exchange state 420, while in parallel (synchronously or simultaneously), it switches EMLSR co-affiliated STA A2 122 from the listening operation state 411 to the disabled frame exchange state 421.

The simultaneous switches last at most the EMLSR active switch delay as specified earlier and shown by reference 499 in the Figure. In practice, the switch for the EMLSR co-affiliated STA having the full radio (only antenna connection is required) is shorter than the switch for the other EMLSR co-affiliated STA having the light radio (due to the required physical and reconfiguration of the full radio chain).

Once the switches have been made, the transmitting EMLSR co-affiliated STA operates the backoff procedure at step 350 on the transmitting EMLSR link. As shown in FIG. 4, the transmitting EMLSR co-affiliated STA A1 121 operates the backoff procedure 422 by decrementing its backoff counter or counters 211 of ACs 210 having data to transmit (only one is shown in the Figure) as long as the medium (transmitting EMLSR link 151) is sensed as idle.

The decrement of the backoff counters is performed in a conventional way.

Should the medium become busy during the decrement, the non-AP MLD may adopt various alternative behaviors.

With a first behavior, the transmitting EMLSR co-affiliated STA remains in the enabled frame exchange state and waits for the medium being back to the idle state. The other EMLSR co-affiliated STAs also keep their current states.

With a second behavior, the EMLSR co-affiliated STAs switch back to the listening operation mode, regardless of the duration field in the frame having put the medium in the busy state. The non-AP MLD waits for a new occasion to select one link for a new EDCA backoff procedure, e.g. to initiate a new frame exchange with the AP MLD. The switch back is therefore for an uncontrolled duration, contrary to the third behavior below.

With a third behavior, the EMLSR co-affiliated STAs still switch back to the listening operation mode, but for a predefined time period corresponding to the Duration field of the frame having put the medium in the busy state. At the end of that time period, the EMLSR co-affiliated STAs switch to their previous states (i.e. to the enabled frame exchange state for the transmitting EMLSR co-affiliated STA, and to the disabled transmitting EMLSR co-affiliated STA for the other EMLSR co-affiliated STA). This switch to the previous states may also be condition to detecting the corresponding link is idle through CCA validation (as described above).

With a fourth behavior, the non-AP MLD first determines the Duration field of the frame having put the medium in the busy state, and decides based on the duration value whether to switch back to the listening operation mode or to remain in the current EMLSR frame exchange mode. For example, if the duration is long, i.e. its value is higher than a high threshold, the EMLSR co-affiliated STAs are switched back to the listening operation mode as in the second behavior (i.e. without time limit). If the duration is average, i.e. its value is comprised between a low threshold and the high threshold, the EMLSR co-affiliated STAs are switched back to the listening operation mode for a predefined time period as in the third behavior. And if the duration is short, i.e. its values is lower than the low threshold, the EMLSR co-affiliated STAs remain in their current states as in the first behavior. In variant, only one threshold is used to discriminate between the first behavior (if duration is low) and the second or third behavior (if duration is high).

When a backoff counter reaches zero (step 360), the transmitting EMLSR co-affiliated STA performs the frame exchange with the AP MLD, in particular it transmits the buffered uplink data of non-AP MLD at step 370. In the example of FIG. 4, transmitting EMLSR co-affiliated STA A1 121, upon having one backoff counter reaching 0, transmits A-MPDU frame 424 intended to AP MLD 110 corresponding to its buffered uplink data, over its corresponding EMLSR link, i.e. link 151.

Optionally, before transmitting A-MPDU frames 424, transmitting EMLSR co-affiliated STA A1 121 may transmit a RTS frame or a CTS-to-self frame in order to have a better protection on the granted channel.

Once the frame exchange ends over link 151, non-AP MLD 120 invokes again the state switching procedure to switch EMLSR co-affiliated STAs A1 121 and A2 122 back to their listening operation state 410, 411. Non-AP MLD 120 therefore switches back to the EMLSR listening operation mode. The switch back is operative an EMLSR Transition Delay (as specified in the EML Capabilities) after the end of the frame exchange.

The first embodiments illustrated through FIGS. 3 and 4 may not be fully satisfactory as EMLSR co-affiliated STA A2 122 cannot receive any initial control frame 265 during the EDCA procedure (backoff decrement).

Second embodiments provide that the initiation of the frame exchange by a “first” EMLSR or EMLMR co-affiliated STA includes:
invoking, by the first co-affiliated STA still in the listening operation state, an enhanced distributed channel access, EDCA, backoff procedure decrementing a backoff counter, to access the first link,
before switching the first affiliated STA from the listening operation state to an enabled frame exchange state, when the backoff counter reaches a value of 0.

In these embodiments, the EML-active non-AP MLD performs contention on the medium (by decrementing its backoff counter or counters) before changing its operation mode into the EML frame exchange mode. It turns out that initial control frames receiving on the other link during the EDCA procedure can be taken into account by the EML-active non-AP MLD.

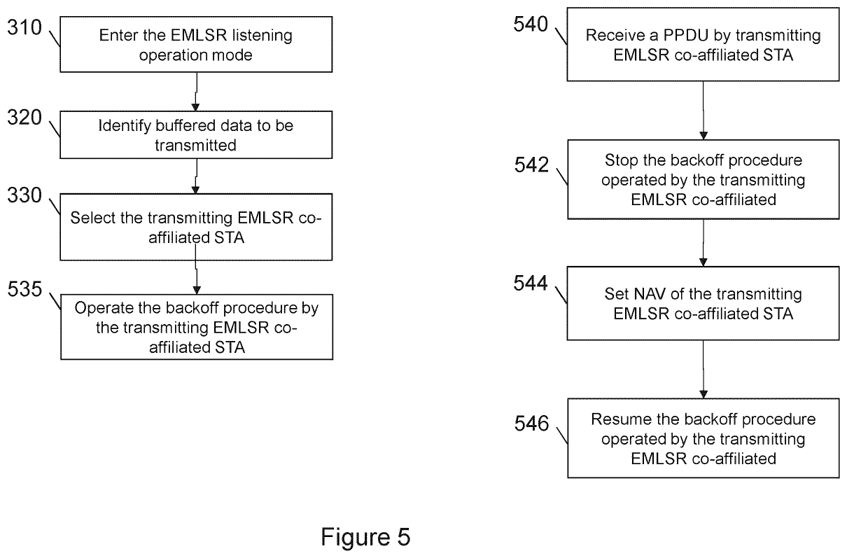

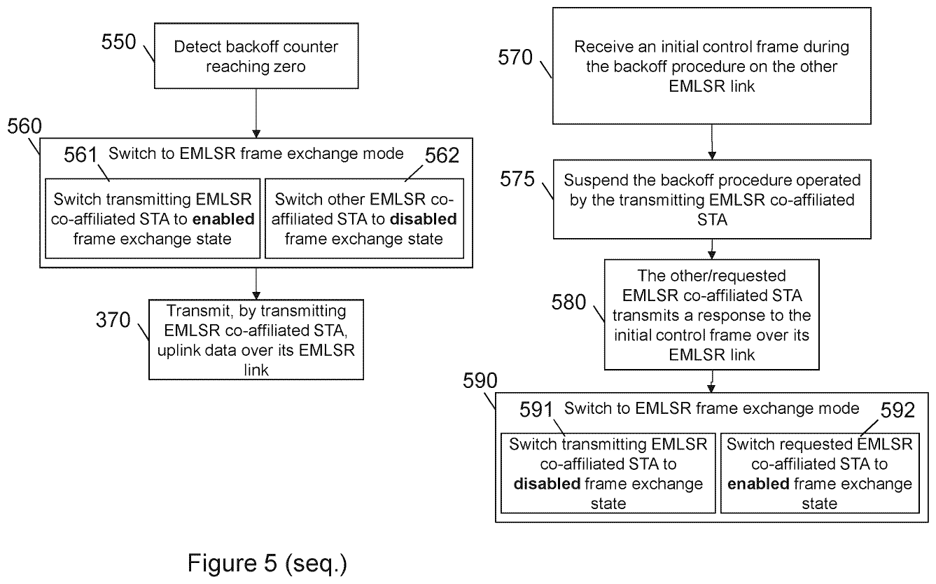

These second embodiments are illustrated by FIGS. 5, 6a, 6b, 7 and 8 which emphasize the EMLSR mode by way of example. The same mechanisms apply to the EMLMR mode given the words matching mentioned above.

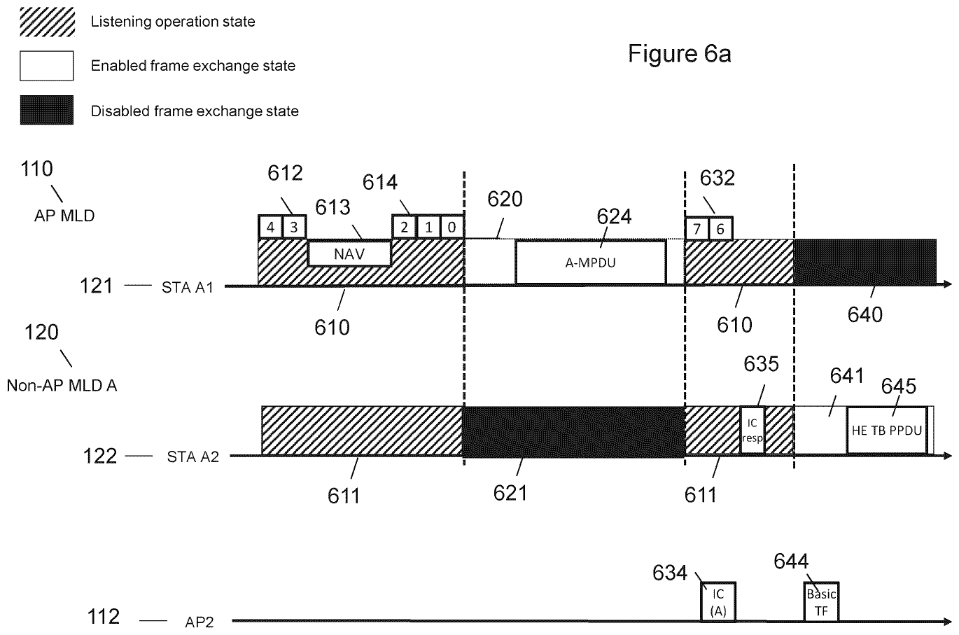

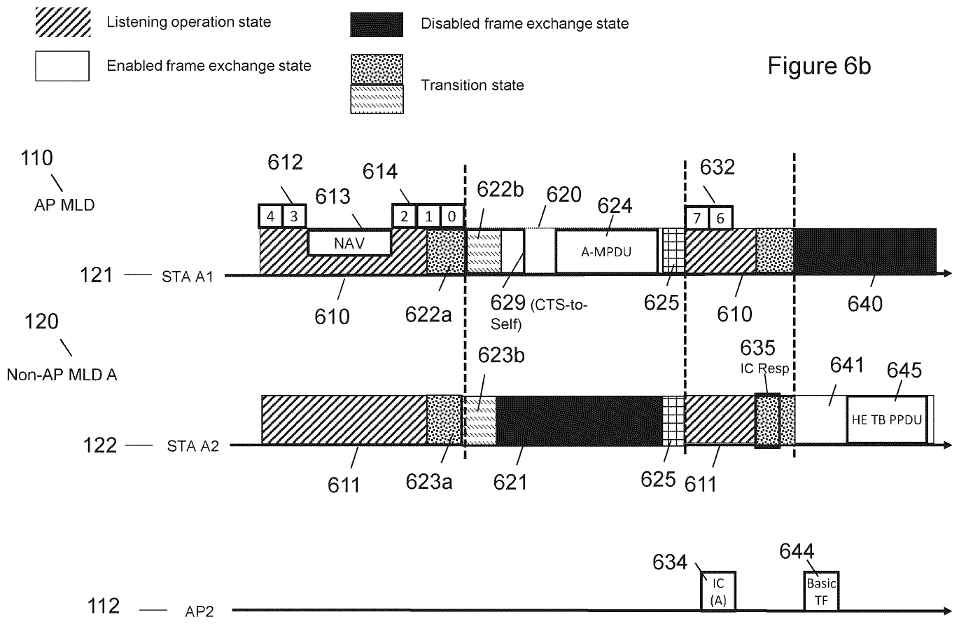

FIG. 5 illustrate, using flowcharts, steps performed by an EMLSR-active non-AP MLD to operate a second contention-based channel access procedure, according to the second embodiments. FIG. 6a schematically illustrates an exemplary timeline of the second contention-based channel access procedure as described in FIG. 5. FIG. 6b schematically illustrates an alternative timeline of the second contention-based channel access procedure as described in FIG. 5.

Similar to FIG. 3, the process starts at step 310 where the non-AP MLD enters the EMLSR listening operation mode, meaning its EMLSR co-affiliated STAs are set in the listening operation state, hence they are simultaneously listening to their respective link. As shown with EMLSR-active non-AP MLD 120 in the EMLSR listening operation mode in FIG. 6a, EMLSR co-affiliated STAs A1 121 and A2 122 are both in the listening operation state 610 and 611.

At step 320, the non-AP MLD waits until it has buffered uplink data to be transmitted to AP MLD 110.

When such data have been identified, the non-AP STA selects, at step 330, one of its EMLSR co-affiliated STAs on which it will operate the contention-based channel access procedure. The selected STA is referred to as transmitting EMLSR co-affiliated STA and the corresponding link is referred to as transmitting EMLSR link. Exemplary selection procedures have been provided previously. In FIG. 6a, EMLSR co-affiliated STA A1 121 is selected as the transmitting EMLSR co-affiliated STA.

Next, at step 535, the non-AP MLD invokes a contention-based channel access procedure to access the transmitting EMLSR link. The transmitting EMLSR co-affiliated STA operates the backoff procedure. As shown in FIG. 6a, transmitting EMLSR co-affiliated STA A1 121 decrements its backoff counter or counters while being in the listening operation state 610.

The decrement of the backoff counters is performed in a conventional way.

Contrary to the D1.5 standard in which an EMLSR co-affiliated STA in the listening operation state should react only when receiving an initial control frame 245 or 265 (i.e. an MU-RTS Trigger frame or a BSRP Trigger frame), embodiments provide that they should react and set their NAV when receiving any type of 802.11 Control frame having a MCS set up to 2 (i.e. a maximum of 24 Mbps). Such frames correspond to any OFDM PPDU or non-HT duplicate PPDU format using a rate of 6 or 12 or 24 Mbps. Indeed, any EMLSR co-affiliated STA (even when equipped with the light radio) is able to decode the field duration of such a frame.

As shown by reference 613, when transmitting EMLSR co-affiliated STA A1 121 performing an EDCA procedure 612 in the listening operation mode 610 receives such a frame (having a MCS value up to 2), it sets or updates its network allocation vector, NAV, based on the duration field of this frame. The EDCA procedure can resume (614) once the NAV reaches zero.

In operation, this means that the transmitting EMLSR co-affiliated STA receives an OFDM PPDU or non-HT duplicate PPDU format using a rate of 6 or 12 or 24 Mbps at step 540.

Upon such reception, the transmitting EMLSR co-affiliated STA stops or suspends its EDCA procedure at step 542, meaning the backoff counter decrement is stopped. Next, at step 544, the NAV of the transmitting EMLSR co-affiliated STA is set or updated based on the duration field of the received frame. The transmitting EMLSR co-affiliated STA next waits for an expiry of its NAV before resuming the EDCA procedure at step 546.

When a backoff counter ultimately reaches zero (step 550-meaning the EDCA procedure ends), the non-AP STA switches from the EMLSR listening operation mode to the EMLSR frame exchange mode at step 560, where the transmitting EMLSR co-affiliated STA is put into the enabled frame exchange state.

For this, the transmitting EMLSR co-affiliated STA is switched (step 561) from the listening operation state to the enabled frame exchange state, while in parallel (synchronously or simultaneously), the other EMLSR co-affiliated STA is switched (step 562) from the listening operation state to the disabled frame exchange state.

In FIG. 6a, when non-AP MLD 120 desires to initiate a frame exchange sequence with AP MLD 110 to transmit its buffered data and has selected EMLSR co-affiliated STA A1 121 as transmitting EMLSR co-affiliated STA and a backoff counter reaches zero, it switches the latter (A1 121) from the listening operation state 610 to the enabled frame exchange state 620, while in parallel (synchronously or simultaneously), it switches EMLSR co-affiliated STA A2 122 from the listening operation state 611 to the disabled frame exchange state 621.

The simultaneous switches last at most the EMLSR active switch delay as specified earlier.

Once the switches have been made, the transmitting EMLSR co-affiliated STA transmits its buffered uplink data at step 370. In the example of FIG. 6a, transmitting EMLSR co-affiliated STA A1 121, upon having one backoff counter reaching 0, transmits A-MPDU frame 624 intended to AP MLD 110 corresponding to its buffered uplink data, over its corresponding EMLSR link, i.e. link 151.

Optionally, before transmitting A-MPDU frames 624, transmitting EMLSR co-affiliated STA A1 121 may transmit a RTS frame or a CTS-to-self frame in order to have a better protection on the granted channel.

Once the frame exchange ends over link 151, non-AP MLD 120 invokes again the state switching procedure to switch EMLSR co-affiliated STAs A1 121 and A2 122 back to their listening operation state 610, 611. Non-AP MLD 120 therefore switches back to the EMLSR listening operation mode. The switch back is operative an EMLSR Transition Delay (as specified in the EML Capabilities) after the end of the frame exchange.

As illustrated still in FIG. 6a, transmitting EMLSR co-affiliated STA A1 121 may start again an EDCA procedure with backoff counter decrement 632 while being in the listening operation state. As other EMLSR co-affiliated STA A2 122 is also listening to its own EMLSR link 152, it is able to receive initial control frame 634 from affiliated AP AP2 112 over that EMLSR link, while transmitting EMLSR co-affiliated STA A1 121 is still being decrementing the backoff counter for the other EMLSR link 151.

Responsive to such reception, non-AP MLD 120 may stop or suspend the EDCA procedure (hence backoff counter decrement) at STA A1 121, while other EMLSR co-affiliated STA A2 122 sends an Initial Control frame response (IC resp.) 635 to trigger or initiate a state change of the EMLSR co-affiliated STAs and therefore perform a frame exchange with AP2 112 over the second link 152. Of course, other strategies may be implemented in which non-AP MLD 120 receiving initial control frame 634 may determine whether it is worth stopping the backoff counter decrement and performing the AP-initiated frame exchange, or it is worth keep going on backoff counter decrement without responding to the initial control frame 634 to obtain its own medium access to initiate its own frame exchange. Decisions (to stop or continue) in these strategies may be based on various parameters and/or policies.

As an example, an amount of buffered data may be taken into account. If the amount is above a threshold, preference is given to the strategy continuing the decrement in order to ensure the non-AP MLD will have its own medium access to transmit. Initial control frame 634 is discarded; no response is sent. On the other hand, if the amount is low, priority is given to the AP-initiated frame exchange (the decrement is stopped and response 635 is sent).

As another example, if transmitting EMLSR co-affiliated STA A1 121 is allocated the full radio stack, it is worth prioritizing an access by this STA to mitigate the time needed to switch the full radio stack to the other EMLSR co-affiliated STA. Hence, transmitting EMLSR co-affiliated STA A1 121 keeps going on decrementing the backoff counter. Initial control frame 634 is discarded; no response is sent. On the other hand, if EMLSR co-affiliated STA A2 122 is allocated the full radio stack, it may worth prioritizing this STA. Hence, the decrement is stopped and response 635 is sent to perform the AP-initiated frame exchange.

As yet other example, if initial control frame 634 is an MU-RTS Trigger frame, suggesting the AP-initiated frame exchange is likely to be a downlink transmission, priority is given to the transmitting EMLSR co-affiliated STA to its own medium access. Hence, transmitting EMLSR co-affiliated STA A1 121 keeps going on decrementing the backoff counter. On the other hand, if initial control frame 634 is a BSRP Trigger frame, suggesting the AP-initiated frame exchange is likely to be an uplink transmission, priority is given to such AP-initiated frame exchange in which the non-AP MLD may have resource units to transmit. Hence, the decrement is stopped and response 635 is sent to perform the AP-initiated frame exchange.

As yet another example, the decision may be based on previous loading (or buffering) of uplink data in a buffer or queue dedicated to a specific one of the EMLSR links. Indeed, some implementations of the ACs in the EDCA mechanism may require preloading of the uplink data in specific queues to be ready to transmit once the associated backoff counter expires. Of course, this preloading may be triggered only in the vicinity of such counter expiry. The decision may therefore be taken based on whether such preloading has happened or not: if uplink data are already preloaded in the buffer dedicated to the first link on which the EDCA procedure is currently performed, transmitting EMLSR co-affiliated STA A1 121 keeps going on decrementing the backoff counter to obtain its own medium access. On the other hand, if uplink data are not yet preloaded in the buffer dedicated to the first link, priority is given to the AP-initiated frame exchange. Hence, the decrement is stopped and response 635 is sent to perform the AP-initiated frame exchange.

In case where response 635 is sent, after an EMLSR active switch delay, non-AP MLD 120 switches to EMLSR frame exchange mode where EMLSR co-affiliated STA A2 122 switches from the listening operation state 611 to the enabled frame exchange state 641 while EMLSR co-affiliated STA A1 121 simultaneously switches from the listening operation state 610 to the disabled frame exchange state 640. Frames 644, 645 are then exchanged during the frame exchange sequence, up to the end of the sequence where the non-AP MLD 120 switches back to the EMLSR listening operation mode (not shown).

Typically, affiliated AP2 112 may transmit a basic trigger frame 644 to EMLSR co-affiliated STA A2 122 in order to allocate uplink resources units for non-AP MLD 120 as specified in IEEE Std 802.11ax™-2021. In such a case, non-AP MLD 120 via EMLSR co-affiliated STA A2 122 transmits a HE TB (High-Efficiency Trigger-Based) PPDU 645 in its allocated resource unit.

The last flowchart of FIG. 5 illustrates such processing which leads the non-AP MLD to suspend or stop or interrupt the EDCA backoff procedure (i.e. the decrement of the backoff counter or counters is stopped) performed on a first link of the EMLSR links upon receiving an initial control frame from the AP MLD over a second link of the EMLSR links.

The other EMLSR co-affiliated STA (other to the transmitting EMLSR co-affiliated STA decrementing its backoff counter) receives an initial control frame from the AP MLD at step 570. This means AP MLD solicits a new EMLSR sequence exchange to be initiated on the EMLSR link corresponding to the other EMLSR co-affiliated STA.

At step 575, the transmitting EMLSR co-affiliated STA suspends its backoff procedure, meaning the decrement of the backoff counter or counters is stopped.

Next, at step 580, the other EMLSR co-affiliated STA transmits a response to the initial control frame over its own EMLSR link.

Thereafter, in line with the EMLSR mechanism, after an EMLSR active switch delay, the non-AP STA switches from the EMLSR listening operation mode to the EMLSR frame exchange mode, at step 590, with a view of putting the other EMLSR co-affiliated STA operative for the frame exchange.

For this, the other/requested EMLSR co-affiliated STA is switched (step 591) from the listening operation state to the enabled frame exchange state, while in parallel (synchronously or simultaneously), the transmitting EMLSR co-affiliated STA is switched (step 592) from the listening operation state to the disabled frame exchange state.

This new mechanism can also be considered in an isolated fashion to the core aspect of the second embodiments. In this context, it relates as such to a communication method in a wireless network, comprising, at a non-AP MLD operating in an active EMLSR mode:
invoking, by a first STA in a listening operation state and affiliated with the non-AP MLD and corresponding to a first link of a set of enabled links in which links the EMLSR mode is applied, an EDCA backoff procedure decrementing a backoff counter, to access the first link,
wherein the decrement of the backoff counter is suspended upon receiving an initial control frame from the AP MLD over a second link of the set.

In embodiments, the decrement is resumed after the frame exchange initiated by the initial control frame ends.

The scenario of FIG. 6a may particularly apply when the transmitting EMLSR co-affiliated STA decrementing the backoff counter is the affiliated STA having the full radio. Indeed, in this case, its switch to the enabled frame exchange state 620 is substantially immediate.

The situation is slightly different when the transmitting EMLSR co-affiliated STA is the affiliated STA having the light radio because the transition between the listening operation state 611 and the enabled frame exchange state 641 is longer. During this transition period, the functionalities of the non-AP MLD may be different, and care should be taken to secure the access to the wireless medium.

FIG. 6b schematically illustrates more detailed scenarios of FIG. 6a taking into account such transition period. The length of the transition period corresponds to the EMLSR active switch delay as specified earlier. The flowcharts of FIG. 5 still apply.

Similar to FIG. 6a, EMLSR co-affiliated STAs A1 121 and A2 122 are both in the listening operation state 610 and 611. EMLSR co-affiliated STA A1 121 is selected as the transmitting EMLSR co-affiliated STA. Transmitting EMLSR co-affiliated STA A1 121 decrements (612) its backoff counter or counters while being in the listening operation state 610. When transmitting EMLSR co-affiliated STA A1 121 receives a Control frame (having a MCS value up to 2), it sets or updates (613) its network allocation vector, NAV, based on the duration field of this frame. The EDCA procedure can resume (614) once the NAV reaches zero.

When a backoff counter of transmitting EMLSR co-affiliated STA A1 121 reaches zero, non-AP MLD 120 switches STA A1 121 from the listening operation state 610 to the enabled frame exchange state 620, while in parallel (synchronously or simultaneously), it switches EMLSR co-affiliated STA A2 122 from the listening operation state 611 to the disabled frame exchange state 621.

In a first implementation, the non-AP MLD operates a CCA during the transition period, i.e., while switching. In other words, to switch the transmitting EMLSR co-affiliated STA, the non-AP MLD invokes a state switching procedure for this STA while the STA is decrementing the backoff counter so that the state switching procedure ends simultaneously to the backoff counter reaching the value of 0 (i.e. expiry of the backoff counter). Of course, the switch for the other EMLSR co-affiliated STA is made in a synchronous/simultaneous manner.

This is illustrated in the Figure by reference 622a for the switch of the transmitting EMLSR co-affiliated STA and by reference 623a for the switch of the other EMLSR co-affiliated STA.

In such a case, the EDCA procedure (backoff counter decrement) is not impacted by the switch mechanism and the two operations (decrement and switch) can be performed simultaneously. The switch mechanism 622a (resp. 623a) is launched in advance corresponding to the EMLSR active switch delay so that the transmitting co-affiliated EMLSR STA A1 121 is in the enabled frame exchange state when the backoff counter reaches zero (and the other co-affiliated EMLSR STA is in the disabled frame exchange state).

Similarly, the listening operation state is restored and operative at the end of the transition period 625 corresponding to the switch back (period defined by the EMLSR Transition Delay set in the EML Capabilities).

In a second implementation, the non-AP MLD is not able to operate a CCA during the transition period, i.e. while switching. In such a case, the switch mechanism 622b (resp. 623b in the Figure) is launched after the backoff counter reaches zero. In other words, to switch the transmitting EMLSR co-affiliated STA, the non-AP MLD invokes a state switching procedure for this STA, responsive to the backoff counter reaching the value of 0. Of course, the switch for the other EMLSR co-affiliated STA is made in a synchronous/simultaneous manner.

References 622b and 623b illustrate this implementation.

Because a risk exists that the medium be in demand by other MLDs, there is an interest to protect the medium during the transition period starting at the expiry of the backoff counter. In that respect, a protection frame 629 as a RTS (Request To Send) or a CTS-to-self (Clear To Send) frame is transmitted by the transmitting EMLSR co-affiliated STA A1 121 during the switch procedure 622b, before the transmission of the buffered uplink data 624 is actually performed. In other words, it is provided that responsive to the backoff counter reaching the value of 0, the non-AP MLD transmits a control frame over the link corresponding to the backoff counter.

To make the protection frame 629 readable by any legacy station on the medium, the frame preferably follows an OFDM PPDU or non-HT duplicate PPDU format using a rate of 6 Mbps, 12 Mbps, or 24 Mbps.

As the length of the transition period is MLD-dependent, the protection frame 629 is preferably sized to protect the medium up to the transmission 624. This may require that the protection frame 629 includes padding to end the control frame after a time point that precedes an end of the state switching procedure by a short interframe space, SIFS. Because the non-AP MLD knows its EMLSR active switch delay and also knows the conventional length of the control frame used, there is no issue in determining the amount of padding needed. The transmitting EMLSR co-affiliated STA A1 121 can therefore start transmission 624 right after frame 629, given the legal SIFS period.

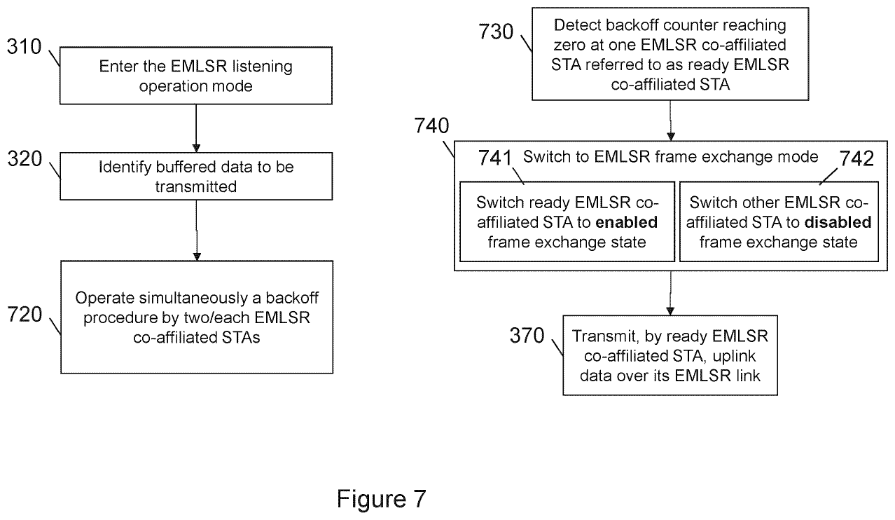

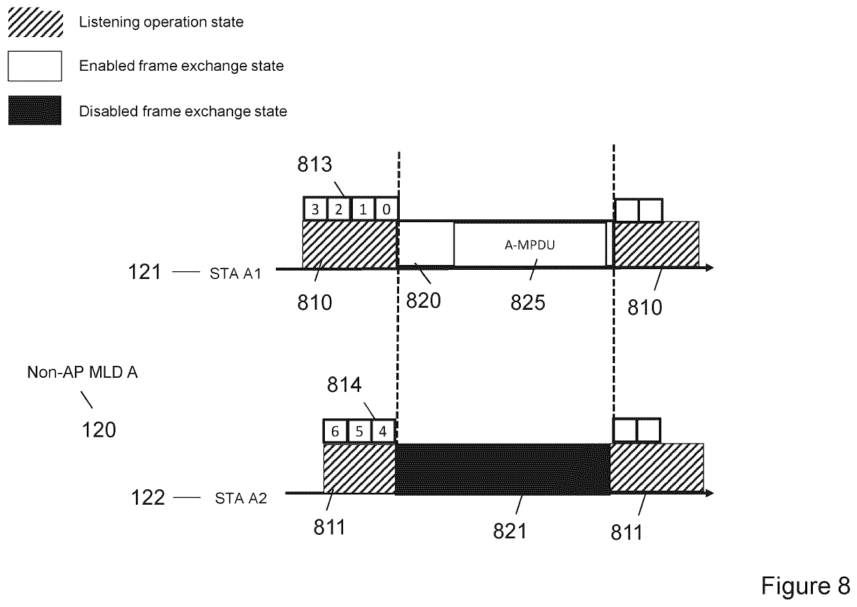

The embodiments above provide that a single EMLSR co-affiliated STA (namely the transmitting one) performs an EDCA procedure, hence decrements its backoff counter or counters. However, to increase chances to gain access to a wireless medium, embodiments may trigger an EDCA procedure at two or more or all EMLSR co-affiliated STAs of the same non-AP MLD. This is now illustrated through FIGS. 7 and 8. EDCA backoff procedures are simultaneously invoked on two or more links of the EMLSR links. Of course, the link for which the corresponding EMLSR co-affiliated station is switched into the enabled frame exchange state is the link corresponding to a backoff counter of the EDCA backoff procedures that first reaches the value of 0. As for the Figures above, the EMLSR mode is emphasized by way of example. The same mechanisms apply to the EMLMR mode given the words matching mentioned above.

FIG. 7 illustrates, using flowcharts, steps performed by an EMLSR-active non-AP MLD to operate a third contention-based channel access procedure, according to third embodiments. FIG. 8 schematically illustrates an exemplary timeline of the third contention-based channel access procedure as described in FIG. 7.

Similar to the embodiments above, the process starts at step 310 where the non-AP MLD enters the EMLSR listening operation mode, meaning its EMLSR co-affiliated STAs are set in the listening operation state, hence they are simultaneously listening to their respective link. As shown with EMLSR-active non-AP MLD 120 in the EMLSR listening operation mode in FIG. 8, EMLSR co-affiliated STAs A1 121 and A2 122 are both in the listening operation state 810 and 811.

At step 320, the non-AP MLD waits until it has buffered uplink data to be transmitted to AP MLD 110.

When such data have been identified, the non-AP STA no longer selects a single EMLSR co-affiliated STA, but operates at step 720 simultaneously and independently random backoff procedures on each EMLSR co-affiliated STA A1 121 (procedure 813) and A2 122 (procedure 814).

Again, as described above, the backoff counter decrement may be suspended upon receiving control frame (hence the NAV is set).

When one backoff counter of either EDCA procedures 813, 814 reaches zero (step 730), the non-AP STA switches from the EMLSR listening operation mode to the EMLSR frame exchange mode at step 740, where the EMLSR co-affiliated STA corresponding to the expired backoff counter is put into the enabled frame exchange state. This EMLSR co-affiliated STA is referred to as “ready EMLSR co-affiliated STA”.

For this, the ready EMLSR co-affiliated STA is switched (step 741) from the listening operation state to the enabled frame exchange state, while in parallel (synchronously or simultaneously), the other EMLSR co-affiliated STA is switched (step 742) from the listening operation state to the disabled frame exchange state.

In FIG. 8, both EMLSR co-affiliated STAs A1 121 and A2 121 decrement their backoff counter or counters. STA A1 121 is the first one having a backoff counter reaching zero, hence it is the ready STA. Responsive to the expiry of the counter, ready STA A1 121 is switched from the listening operation state 810 to the enabled frame exchange state 820, while in parallel (synchronously or simultaneously), EMLSR co-affiliated STA A2 122 is switched from the listening operation state 811 to the disabled frame exchange state 821.

The simultaneous switches last at most the EMLSR active switch delay as specified earlier.

Once the switches have been made, the ready EMLSR co-affiliated STA transmits its buffered uplink data at step 370. In the example of FIG. 8, ready EMLSR co-affiliated STA A1 121 transmits A-MPDU frame 825 intended to AP MLD 110 corresponding to its buffered uplink data, over its corresponding EMLSR link, i.e. link 151 to affiliated AP AP1 111 of AP MLD 110.

Optionally, before transmitting A-MPDU frames 825, ready EMLSR co-affiliated STA A1 121 may transmit a RTS frame or a CTS-to-self frame in order to have a better protection on the granted channel.

After the end of the frame exchange operated by ready EMLSR co-affiliated STA A1 121 plus an EMLSR Transition Delay specified in the EML capabilities, the non-AP MLD 120 switches back to the EMLSR listening operation mode, meaning that the ready EMLSR co-affiliated STA A1 121 switches back to the listening operation state 810 as well as the other EMLSR co-affiliated STA A2 122 (listening operation state 811).

As described previously with reference to FIGS. 1a and 1b, in an MLD, each AC is mapped onto one EDCA engine per Link.

In the case of a Multi-Radio MLD able to Simultaneous Transmission and Reception (STR), each affiliated STA operates on a link independently of other affiliated STA operating on other links. In other words, the EDCA engine for a link can operate in a legacy fashion as it is independent of other EDCA engines for other links. In the example of FIG. 1b, this means EDCA engines 221-x, 221-y and 221-z and their respective backoff entities 211 can operate independently of the other in a legacy fashion.

However, in the case of an MLD operating in an EML mode, be it EMLSR or EMLMR mode, an affiliated STA operating on an EMLSR or EMLMR link is dependent from another affiliated STA operating on another EMLSR or EMLMR link.

For example, when an EMLSR co-affiliated STA switches in the enable frame exchange state on its EMLSR link, the other EMLSR co-affiliated STA is automatically switched in the disable frame exchange state on its other EMLSR link. This means that the EDCA engine handling an EML link has some dependency from another EDCA engine handling another EML link of the same EMLSR or EMLMR links set. This is due to the fact that, on an MLD operating in the EML mode, a data frame exchange can effectively be done on only one EML link of the set at a time. In the example of FIG. 1b, EDCA engines 221-x, 221-y and 221-z and their respective backoff entities 211 cannot operate independently of the other in a legacy fashion.

That is why embodiments of the present invention seek to arrange the EDCA procedure to match with EMLSR or EMLMR particularities of the EMLSR or EMLMR co-affiliated STAs.

At a non-AP MLD operating in an active EML mode first, a backoff counter driving or governing EDCA access to a second link of the EMLSR or EMLMR set can be suspended responsive to starting a frame exchange with an AP MLD over a first link of the set. This avoids obtaining EDCA access to the second link while the corresponding co-affiliated STA is not available (because the radio resources have been allocated to the co-affiliated STA due to the frame exchange). It turns outs that the efficiency of the EDCA procedure is improved.

As an example of particular EDCA-related issues, assuming the MLD is operating in the EMLSR or EMLMR mode on Links 20-x and 20-z, and BC[x3] reaches 0 granting access for the MLD to Link 20-x for transmission of its MSDUs stored in AC3, the following dependencies appear:
the three other backoff counters BC[x0], BC[x1], BC[x2] belonging to the same EDCA engine 221-x are suspended due to legacy 802.11 behaviour,
the four backoff counters BC[z0], BC[z1], BC[z2], BC[z3] belonging to the EDCA engine 221-z are also suspended since Link 20-z is no longer operative for the MLD. This dependency is specific to an MLD operating in an EML mode on Links 20-x and 20-z. Indeed, when the affiliated STA 201-x switches in the enable frame exchange state on the EMLSR/EMLMR Link 20-x for transmission, the other co-affiliated STA 201-z is automatically switched in the disable frame exchange state on the other EMLSR/EMLMR Link 20-z. In the disable frame exchanged state, the affiliated STA is not able to handle the EDCA backoff procedure because medium sensing is not possible in this state,
once the transmission of the MSDUs stored in AC3 is completed on Link 20-x, the MLD operating in the EML mode switches back in the listening operation state on both Links 20-x and 20-z. At this stage, another dependency appears between EDCA engine 221-x and EDCA engine 221-z, especially between their respective backoff counters BC[x3] and BC[z3]:
   for EDCA engine 221-x, the resumption or restart of its backoff counters BC[x0], BC[x1], BC[x2], BC[x3] can be handled in a legacy fashion: BC[x0], BC[x1], BC[x2] are resumed, BC[x3] is re-initialized.
   for EDCA engine 221-z, the resumption or restart of its backoff counters BC[z0], BC[z1], BC[z2], BC[z3] raises issues. While BC[z0], BC[z1], BC[z2] may be merely resumed because no data from the corresponding ACs have been transmitted, this is not so trivial for BC[z3] corresponding to the AC for which a transmission just occurred. Indeed, the mere resuming of BC[z3] may create fairness issues from among the ACs of the MLD as on the next round, BC[z3] may gain access to Link 20-z for transmission, once again, of MSDUs stored in AC3.

New strategies governing the EDCA backoff restart for STAs affiliated with a non-AP MLD operating in an EML mode are therefore proposed. Especially, embodiments of the invention specify novel EDCA backoff restart procedures for a STA affiliated with a non-AP MLD operating on a second EMLSR or EMLMR link after an UL transmission took place on a first EMLSR or EMLMR link of the same set.

In this respect, responsive to ending the frame exchange over the first link, a restart strategy selected based on a property of the frame exchange is applied to restart the suspended backoff counter (driving access to the second link).

Accordingly, the strategy or policy to restart the backoff counter for a given link is made dependent on what happened (frame exchange) on another link. This is not a conventional EDCA approach. It turns out that the network access fairness issue can be mitigated by adopting or adjusting appropriate EDCA backoff restart procedures. In particular, the backoff counter associated with an AC for a given link may be penalized when data from the same AC have just been transmitted over the other link of the same EMLSR or EMLMR links set.

With more details, restart procedures are proposed for a backoff counter 211 BC[n,m] operating in EDCA engine 221-n for a second EMLSR or EMLMR link n, after an uplink (UL) transmission of MSDUs for an ACm took place on a first EMLSR or EMLMR link of the same EMLSR or EMLMR Links set.

Practically, plural backoff counters driving EDCA to the second link for respective plural access categories (e.g. one for each of the four ACs) are suspended in response to starting the frame exchange. In that case, the restart strategy may be applied to the backoff counter or counters of the plural suspended backoff counters that correspond to access categories exchanged during the frame exchange. In other words, if data from AC2 and AC3 are uplink-transmitted over link 1 during the frame exchange, the suspended backoff counters corresponding to AC2 and AC3 for link 2 may be restarted using an adapted restart strategy, while the suspended backoff counters corresponding to the other ACs (AC0 and AC1) can be resumed in a conventional EDCA manner.

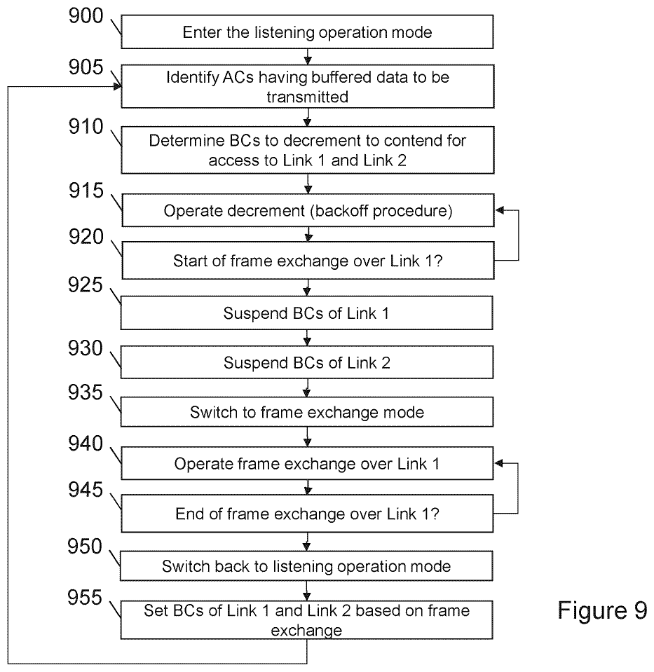

FIG. 9 illustrates, using a flowchart, steps handling backoff counter restart in an EML mode, according to embodiments of the invention. For ease of explanation, it is mainly made reference to the EMLSR mode only, whereas the same applies to the EMLMR mode.

The process starts at step 900 where the non-AP MLD enters the (EMLSR or EMLMR) listening operation mode, meaning its co-affiliated STAs are set in the listening operation state, hence they are simultaneously listening to their respective links. The non-AP MLD may enter the listening operation mode as a response to receiving an EML OM Notification frame with its corresponding Mode subfield (EMLSR or EMLMR Mode subfield in the EML Control field) set to 1. In a variant, the non-AP MLD may enter the listening operation mode by switching back from the frame exchange mode.

The non-AP MLD may have all or part of its ACs in the EDCA mode (i.e., using EDCA parameters for medium contention) or already in the MU EDCA mode (i.e. using MU EDCA parameters for medium contention) if it has recently profited of a trigger-based MU UL transmission for the corresponding AC. As known, the MLD may switch back one AC from the MU EDCA mode to the EDCA mode upon expiry of the respective MUEDCATimer.

At step 905, the non-AP MLD waits until it has buffered uplink data to be transmitted to AP MLD 110. As mentioned above, such data may be provided by upper layers and stored in the buffers 210 of the non-AP MLD. The non-AP MLD identifies all the ACs having buffered data to be transmitted to the AP MLD.

Next, at step 910, the non-AP MLD determines the backoff counters to be activated to contend access to the EMLSR or EMLMR links (Link 1 and Link 2 in the Figure).

In some embodiments like those based on the default TID-to-Link mapping, all the backoff counters corresponding to the identified ACs for the links have to be used for medium contention.

In some embodiments where a TID-to-Link has been negotiated, some TIDs (hence corresponding ACs) may be forbidden on one of the links. In that case, the non-AP MLD lists all the backoff counters corresponding to the identified ACs for the links of the EMLSR or EMLMR links set that are not forbidden given the negotiated TID-to-Link mapping.

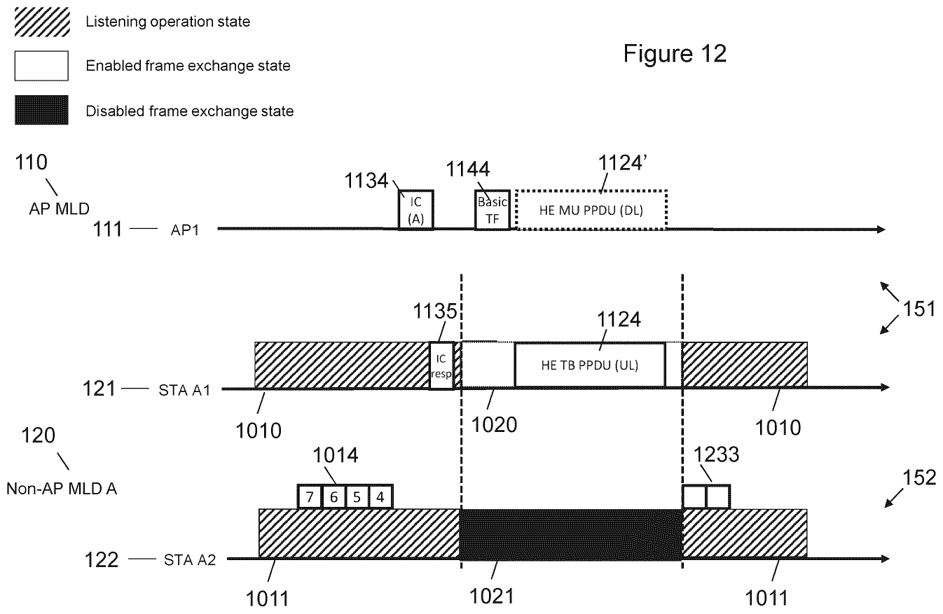

In other embodiments, the non-AP MLD may decide to contend for access to only one of the links of the set rather than concurrently contending to both links. To do so, it selects one of its co-affiliated STA on which it will operate the contention-based channel access procedure. The selected STA is referred to as transmitting co-affiliated STA and the corresponding link is referred to as transmitting link. In embodiments illustrated in FIG. 12 described below; the non-AP MLD decides to contend for access to Link 152 only. The non-AP MLD may also decide to contend for access to different links for different ACs.

Any selection procedure can be used. For example, it may rely on a round-robin strategy or a random strategy or a load-balancing strategy based on the links occupancy (in such a case, the link of the set with the less occupation rate is preferably selected).

In yet other embodiments, the non-AP MLD takes into account the AIFSN value applicable for each backoff counter in order to determine when the decrement of each of them can be started.

Once the backoff counters to activate are known, they are started at step 915: they are decremented at each time slot as long as the corresponding link is sensed as idle. This lasts until a frame exchange starts over one of the links of the set (test 920).

Various events allow the non-AP MLD to detect a frame exchange starts.

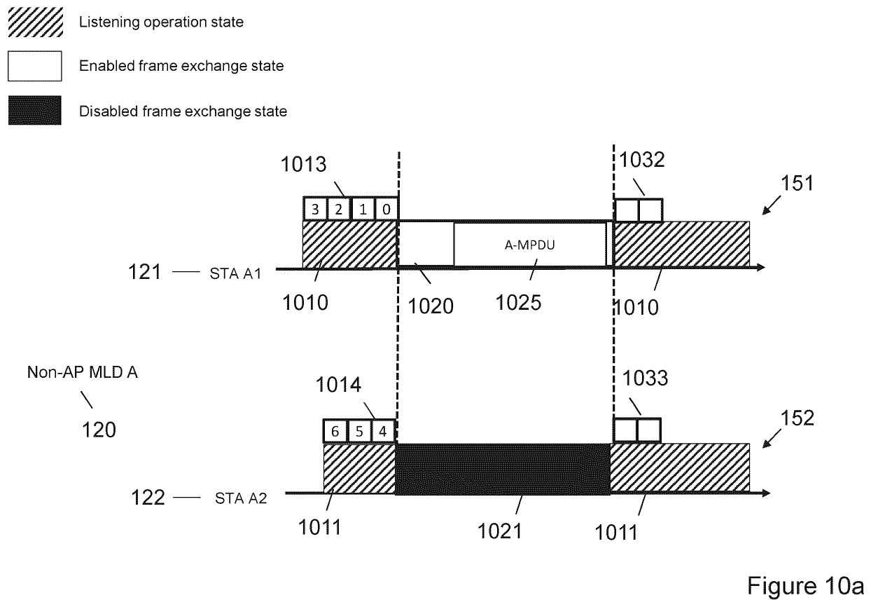

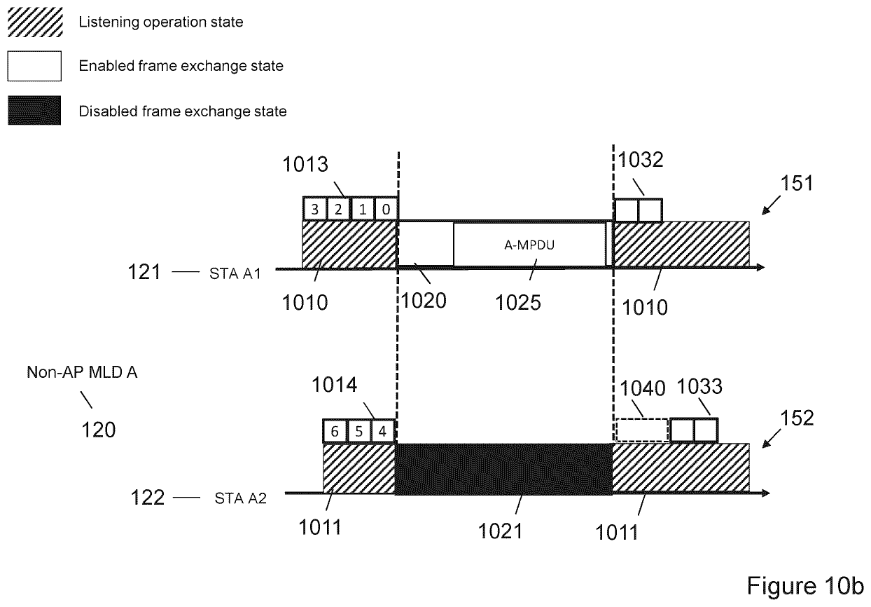

In some embodiments, corresponding for example to FIGS. 10a and 10b described below, the event is an expiry of one of the decremented backoff counters. Indeed, in that case, the non-AP MLD gains access to the link corresponding to the expiring backoff counter, to transmit data belonging to the AC corresponding to the expiring backoff counter.

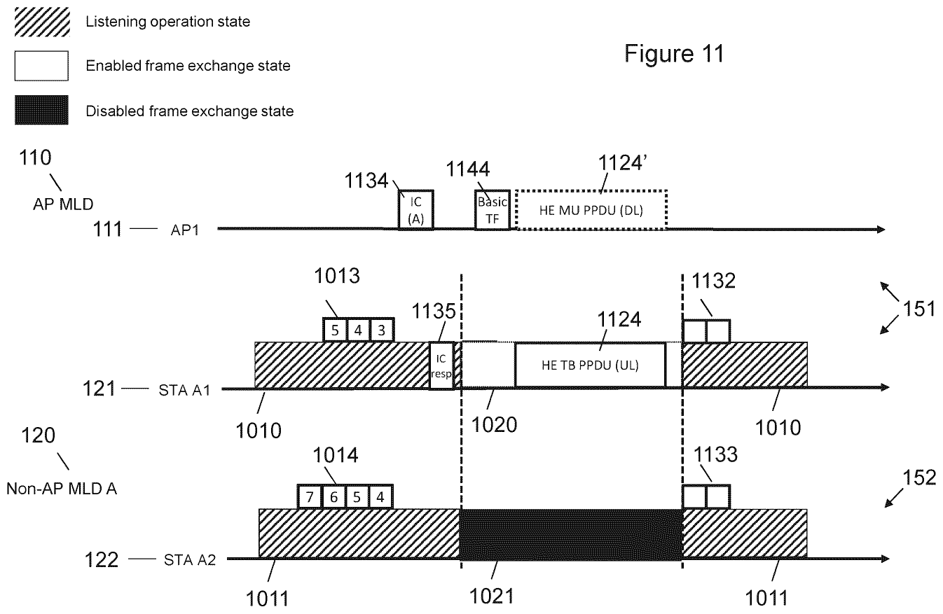

In other embodiments specific to the EML modes and corresponding for example to FIGS. 11 and 12 described below, the event is the reception of an initial frame (known as initial control frame 245 in the EMLSR mode) over one of the links, from the AP MLD. Indeed, in that case, the non-AP MLD is engaged in a frame exchange over that link.

Upon detecting such start of a frame exchange over one of the EMLSR or EMLMR links, let say Link 1, the non-AP MLD suspends all the other active backoff counters contending for access to the same link at step 925. This is a legacy behavior for an 802.11 station.

Due to the dependencies between the links of the set, the non-AP MLD also has to suspend all the active backoff counters contending for access to the other link at step 930 (because the non-AP MLD will no longer be operative on this other link due to the switch described below).

Next, at step 935, a state switching procedure is invoked by the non-AP MLD to switch its mode from the listening operation mode to the frame exchange mode, where the co-affiliated STA corresponding to Link 1 (over which the frame exchange starts) is put into the enabled frame exchange state.

For this, this co-affiliated STA is switched from the listening operation state to the enabled frame exchange state to perform the frame exchange, while in parallel (synchronously or simultaneously), the other co-affiliated STA (of Link 2) of the EMLSR or EMLMR links set considered is switched from the listening operation state to the disabled frame exchange state.

The non-AP MLD is now ready to perform the frame exchange with the AP MLD over Link 1 (step 940).

Once the frame exchange ends over Link 1 (test 945), the non-AP MLD invokes again the state switching procedure to switch its co-affiliated STAs back to their listening operation states (step 950). The non-AP MLD therefore switches back to the listening operation mode. The switch back is operative an EMLSR Transition Delay or EMLMR Delay (as specified in the EML Capabilities) after the end of the frame exchange.

Next, the backoff counters of Links 1 and 2 (suspended at steps 925 and 930) are prepared at step 955 for subsequent contention, i.e., for their respective next decrement.

The backoff counters of Link 1 (i.e., the one where the frame exchange took place) may be restarted in a conventional manner.

In case where one backoff counter has expired (i.e., the non-AP MLD gained access to the medium for the corresponding AC, meaning SU transmission) the backoff counter is reinitialized using an updated contention window−CW=CWmin in case of successful uplink transmission or CW=min (2.CW, CWmax) in case of failed uplink transmission. The other backoff counters not concerned by the transmission are merely resumed from their last values.

On the other hand, in case where no backoff counter has expired (i.e. the frame exchange is initiated by the AP MLD), the backoff counter or counters of the ACs concerned by the frame exchange is or are merely resumed.

These ACs may remain in the current EDCA mode for Link 1 (be it the legacy EDCA mode using the set of EDCA parameters for the corresponding BCs on Link 1 or the MU EDCA mode using the set of MU EDCA parameters for the corresponding BCs on Link 1), in which case the contention window for the next re-initialization of the BC is updated to CWmin. One understands that an AC is in a given EDCA mode for a Link means that the use of backoff counter corresponding to this AC to access the Link is driven by the set of parameters applicable for the given EDCA mode.

The non-AP MLD may also switch these ACs for Link 1 from the legacy EDCA mode into the MU EDCA mode (i.e., using the set of MU EDCA parameters for medium contention) if currently in the legacy EDCA mode and the MU EDCA mode is activated on Link 1. It may then reinitialize their MUEDCATimer in case the frame exchange includes successful trigger-based MU UL transmission. The contention window for the next re-initialization of the BC may be CWmin defined in the applicable set of parameters. The other backoff counters not concerned by the frame exchange are merely resumed from their last values.

Alternatively, the non-AP MLD may switch these ACs for Link 1 from the current EDCA mode (be it legacy EDCA mode or MU EDCA mode) into a so-called EML EDCA mode. Indeed, a new EML EDCA mode (e.g. a EMLSR EDCA mode and a EMLMR EDCA mode if a difference is to be provided between the management of the two EML modes) may be defined providing another set of EML EDCA parameters (in beacon frames e.g.) to set the backoff counter for the concerned AC to access to Link 1, as well as a distinct EMLEDCATimer to drive the switch back to the convention EDCA mode for the AC.

The switch of the ACs for Link 1 into another EDCA mode may be independent of any switch of the ACs for Link 2 into also other EDCA modes as described below.

However, preferably, the switches of the ACs for Link 1 and Link 2 are dependent one from the other. For example, the ACs for Link 1 and Link 2 may be switched to the same other EDCA mode (MU EDCA mode, EML EDCA mode, EMLSR EDCA mode, EMLMR EDCA mode) although their applicable sets of parameters have different values or not. In another example, when an AC for one of the links of the EMLSR/EMLMR set is switched into another EDCA mode, the same AC for the other links are also switched into another EDCA mode which may be different. For example, an AC for Link 1 where the frame exchange took place may be switched into the MU EDCA mode while the same AC for the other links of the set (Link 2 in the example) are switched into any EML EDCA mode, or the reverse.

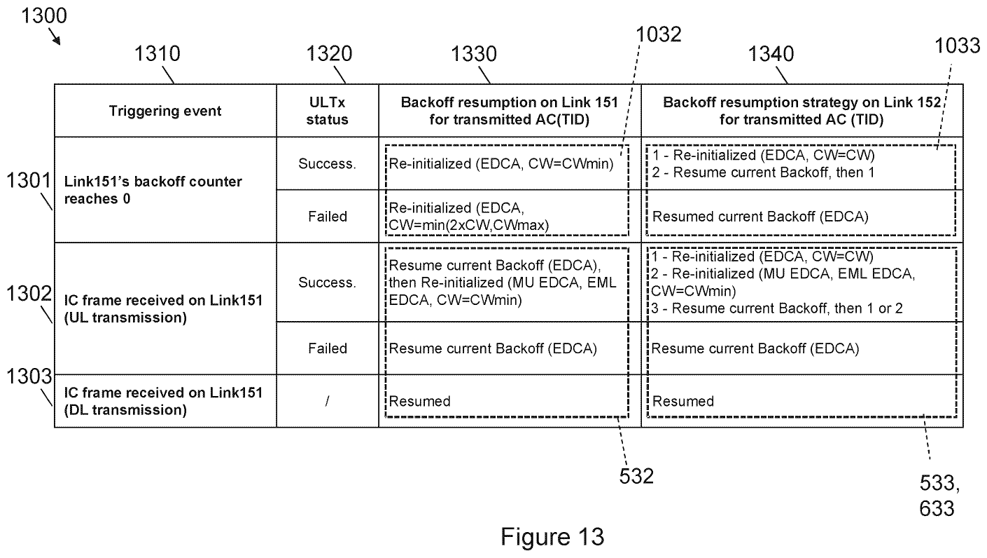

This is summarized in column 1330 of FIG. 13 described below.

The backoff counters of Link 2 (i.e. the other link of the EMLSR or EMLMR Links set) are also prepared for the next medium contention. It is recalled that these suspended backoff counters have not expired. The backoff counters of the ACs not concerned by the frame exchange over Link 1 are merely resumed from their last values.

The used restart strategy for the backoff counter or counters of the ACs concerned by the frame exchange over Link 1 is based on a property of the frame exchange.

In embodiments, it is based on whether the frame exchange is a successful uplink transmission to the AP MLD or a failed one, i.e. based on a status of the frame exchange. For instance, the backoff counter is merely resumed from its last value in case of failed uplink transmission in the frame exchange. The same mere resuming applies for a downlink transmission. Indeed, in all cases, the non-AP MLD has not taken advantage of the transmission opportunity over Link 1. On the other hand, the backoff counter may be reinitialized, even if having not expired, in case of successful uplink transmission in the frame exchange. This is to compensate the transmission opportunity over Link 1, with respect to the fairness between the MLDs of the network.

In some embodiments, that may be combined with the previous ones, the strategy is based on whether the frame exchange includes single-user uplink transmission to the AP MLD or multi-user triggered-based uplink transmission to the AP MLD or only downlink transmission from the AP MLD, i.e., based on a nature of the frame exchange.

For instance, a backoff counter for an AC concerned by the frame exchange may be
resumed in case of downlink transmission or failed uplink transmission in the frame exchange,
while it may be reinitialized using a current contention window, before starting decrementing the backoff counter or may be resumed from its current value, in case of successful SU UL transmission in the frame exchange,
or may be reinitialized using a current contention window or a new contention window associated with a new EDCA mode, before starting decrementing the backoff counter, or may be resumed from its current value, in case of successful multi-user triggered-based uplink transmission in the frame exchange. As for Link 1 above, the concerned AC may remain in the current EDCA mode for Link 2 (legacy EDCA mode or MU EDCA mode) or alternatively it may be switched from the legacy EDCA mode into the MU EDCA mode or the EML EDCA mode, and then the MUEDCATimer or the applicable EMLEDCATimer may be reinitialized.

The switch of the ACs for Link 2 into a new EDCA mode may be independent of any switch of the ACs for Link 1 into also other EDCA modes as described above. However, preferably, the switches of the ACs for Link 1 and Link 2 are dependent one from the other as described above.

“new EDCA mode” above refers to any of MU EDCA mode, EML EDCA mode, EMLSR EDCA mode and EMLMR EDCA mode.

This is summarized in column 1340 of FIG. 13.

Where the frame exchange includes a cascaded sequence of transmissions (this is for instance the case when the frame exchange is initiated by the AP MLD, which cascades several TXOPs), a successful transmission has priority over the failed uplink transmissions (for a given AC) in the restart strategy selection. In other words, as soon as one uplink transmission is successful for a given AC, the above strategy to be used in case of successful transmission applies for the backoff counter of the AC, without consideration of the strategy related to failed transmissions.

Next to step 955, the backoff counters are ready for next medium contention if there are still buffered data to be transmitted (loops back to step 905).

FIGS. 10a and 10b schematically illustrate an exemplary timeline of a first EMLSR or EMLMR operation case involving a backoff counter restart procedure according to embodiments of the invention, when the triggering event of the frame exchange is an expiry of a backoff counter driving an EDCA to Link 1 (link 151). It means that the frame exchange that takes place is a single user (SU) uplink transmission.

In FIG. 10a, both co-affiliated STAs A1 121 and A2 122 decrement their backoff counter or counters (step 915 above), while few backoff counters are shown for the sake of illustration. Only one backoff counter decrement 1013 is represented for the co-affiliated STA A1 121 for Link 151 and one backoff counter decrement 1014 is represented for the co-affiliated STA A2 122 for Link 152. As example, the backoff counter decrements 1013 and 1014 correspond to the backoff counters for the same AC, here AC3 for which an UL transmission is to be occurred during the frame exchange. These counters are respectively BC[151,3] and BC[152,3].

For both links 151 and 152, the other backoff counters BC[151,0], BC[151,1], BC[151,2] and BC[152,0], BC[152,1], BC[152,2] for the other ACs are also decremented concurrently to BC[151,3] and BC[152,3].

STA A1 121 is the first one having its backoff counter expiring (step 920), here BC[151,3] reaches 0. Hence, STA A1 121 is the ready STA for transmission. Responsive to the expiry of the counter BC[151,3], ready STA A1 121 is switched (step 935) from the listening operation state 1010 to the enabled frame exchange state 1020, while in parallel (synchronously or simultaneously), co-affiliated STA A2 122 is switched from the listening operation state 1011 to the disabled frame exchange state 1021. Also responsive to the expiry of the counter BC[151,3], the backoff counter decrement 1014 of backoff counter BC[152,3] is suspended (step 930). The other backoff counters of Links 151 and 152 are also suspended (steps 925, 930).

The simultaneous switches last at most the EMLSR active switch delay or the EMLMR active switch delay as specified earlier.

Once the switches have been made, ready STA A1 121 transmits its buffered uplink data at step 1025 (step 940). In the example of FIG. 10a, ready co-affiliated STA A1 121 transmits A-MPDU frame 1025 intended to AP MLD 110 corresponding to its buffered uplink data for its AC3, over its corresponding EMLSR or EMLMR link, i.e. link 151 to affiliated AP AP1 111 of AP MLD 110.

Optionally, before transmitting A-MPDU frames 1025, ready co-affiliated STA A1 121 may transmit a RTS frame or a CTS-to-self frame in order to have a better protection on the granted channel.

After the end of the frame exchange operated by ready co-affiliated STA A1 121 plus an EMLSR Transition Delay or EMLMR Delay specified in the EML capabilities, non-AP MLD 120 switches back to the listening operation mode (step 950), meaning that ready co-affiliated STA A1 121 switches back to the listening operation state 1010 as well as the other co-affiliated STA A2 122 (listening operation state 1011).

At this stage, both co-affiliated STAs A1 121 and A2 122 can handle the restart of their backoff counter or counters. On FIG. 10a, backoff counter restart 1032 is represented for co-affiliated STA A1 121 for Link 151 and backoff counter restart 1033 is represented for co-affiliated STA A2 122 for Link 152. Backoff counter restarts 1032 and 1033 correspond, respectively, to backoff counters BC[151,3] and BC[152,3].

With reference to the table shown in FIG. 13, backoff counter restarts 1032 and 1033 depend on the status of the previous UL transmission of A-MPDU frames 1025, i.e. whether it was a successful or failed SU UL transmission. The case of FIG. 10a is shown in the first row 1301.

Strategies for backoff counter restart 1032 of BC[151,3] are shown in column 1330.

If the previous SU UL transmission 1025 was successful, backoff counter BC[151,3] is handled in a legacy fashion: it is merely re-initialized from range [0, CW=CWmin] using EDCA parameters and processed using the conventional EDCA backoff procedure.

If the previous SU UL transmission 1025 was not successful, backoff counter BC[151,3] is handled in a legacy fashion: it is merely re-initialized from range [0, CW=min (2xCW,CWmax)] using EDCA parameters and processed using the conventional EDCA backoff procedure.

Strategies for backoff counter restart 1033 of BC[152,3] are shown in column 1340.

If the previous SU UL transmission 1025 was successful, backoff counter BC[152,3] may be re-initialized from range [0, CW=CW] using EDCA parameters and processed using the conventional EDCA backoff procedure. In this case, BC[152,3] is re-initialized to take into account its dependency with BC[151,3] and the fact that the non-AP MLD benefited from the transmission opportunity over Link 151. This restores some fairness to compensate this additional transmission opportunity for the MLD. However, as no UL transmission occurred from STA A2 122 on Link 152, the Contention Window may keep the same (current) value to reflect the current status on this link.

Alternatively, it may be resumed from its current value and processed using the conventional EDCA backoff procedure, and then be re-initialized from range [0, CW=CW] and processed using the conventional EDCA backoff procedure.

If the previous SU UL transmission 1025 was not successful, backoff counter BC[152,3] may be resumed from its current value and processed using the conventional EDCA backoff procedure. In this case, as the SU UL transmission 1025 was not successful for AC3 on Link 151, the AC3 priority on Link 152 is kept as it is by merely resuming the corresponding backoff counter BC[152,3] from its current value.

FIG. 10b is similar to FIG. 10a except that an optional synchronization delay 1040 is added before backoff counter restart 1033 on Link 152.

This optional synchronization delay reflects the fact that co-affiliated STA A2 122 being in the disabled frame exchange state 1021 during the frame exchange, it may have lost synchronization with the medium. Indeed, STA A2 122 was not able to sense Link 152 during the UL transmission 1025 of STA A1 121 on Link 151. This optional synchronization delay thus allows co-affiliated STA A2 122, having switched back from the disabled frame exchange state 1021 to the listening operation state 1011, to resynchronize on the medium before restarting any new EDCA procedure to contend for access to Link 152. In other words, in these embodiments, the restart strategy includes a synchronization delay from the end of the frame exchange, before restarting the backoff counter.

Synchronization is lost if the disabled frame exchange state 1021 lasts more than a threshold called aMediumSyncThreshold in IEEE P802.11be/D1.5 draft. Therefore, applying the synchronization delay in the restart strategy is conditional to a duration of the frame exchange greater than such a predefined threshold.

The length of the synchronization delay is defined by the value contained in the Medium Synchronization Information field, if present, of the Basic Multi-Link element in the most recent frame received from the corresponding affiliated AP, i.e., AP2 112 in the Figure.

In practice, if a synchronization loss occurred, the restart of the backoff counters for Link 152 is frozen: a timer called MediumSyncDelay in the IEEE P802.11be/D1.5 draft and initialized with the Medium Synchronization Information field value is started by STA A2 122 immediately after the switch back (step 950) to the listening operation state 1011. The timer is counted down, and upon expiry, the backoff counters for Link 152 are started (decremented).

During the timer counting down, co-affiliated STA A2 122 may recover from desynchronization thanks, for example, to the reception of any 802.11 Control frame. Indeed, in that case, the radio stack of co-affiliated STA A2 122 is realigned with the timing of Link 152, because it is able to decode the field duration of such a frame. In practice, the MediumSyncDelay timer may be reset to zero upon such a successful reception of any type of 802.11 Control frame having a MCS set up to 2 (i.e. a maximum of 24 Mbps). Such reception allows the synchronization delay 1040 to be shortened and the NAV of STA A2 122 to be updated.

In the scenario of FIG. 10b, co-affiliated STA A2 122 may be considered as resynchronized to the medium either upon successful reception of an 802.11 Control frame, or once the MediumSyncDelay timer expires. The next decrement of its backoff counters can then be started.

FIG. 11 schematically illustrates an exemplary timeline of a second EMLSR or EMLMR operation case involving a backoff counter restart procedure according to embodiments of the invention, when the triggering event of the frame exchange is the reception of an initial frame (in the EMLMR mode) or initial control frame (in the EMLSR mode) over Link 151 from the AP MLD. In this scenario, the initial frame is received while backoff counters driving EDCA for the same AC to Link 151 and Link 152 respectively are being decremented.

In FIG. 11, both co-affiliated STAs A1 121 and A2 122 decrement their backoff counter or counters (step 915 above). Similar to FIG. 10a, few backoff counters are shown for the sake of illustration. In the example, it is assumed that traffic from AC3 will be exchanged during the frame exchange, hence only BC[151,3] and BC[152,3] are illustrated. The same teachings as below apply for any AC (whose backoff counters are simultaneously being decremented), known as “transmitted AC”, for which data are to be exchanged during the frame exchange.

While being in the listening operation state 1010 and while its transmitted backoff counter or counters for the transmitted AC or ACs are being decremented 1013, co-affiliated STA A1 121 receives Initial Control frame (IC) or Initial frame 1134 from affiliated AP AP1 111 over Link 151. Co-affiliated STA A2 122 also decrements its backoff counter or counters 1014.

Responsive to such reception, non-AP MLD 120 suspends transmitted backoff counter decrements 1013 and 1014 as well as any other backoff counter for the two links (steps 925, 930), initiates a state change of the co-affiliated STAs (step 935) and then sends Initial Control frame response (IC resp.) or Initial frame response 1135 to affiliated AP AP1 111.

After an EMLSR active switch delay or EMLMR active switch delay, co-affiliated STA A1 121 has switched from the listening operation state 1010 to the enabled frame exchange state 1020 while co-affiliated STA A2 122 has switched simultaneously from the listening operation state 1011 to the disabled frame exchange state 1021.

Once the switches have been made, co-affiliated STA A1 121 performs the frame exchange for the transmitted AC or ACs with affiliated AP AP1 111 over Link 151.

Typically, affiliated AP1 111 may transmit a basic trigger frame 1144 to co-affiliated STA A1 121 in order to allocate uplink (UL) resources units for non-AP MLD 120 as specified in IEEE Std 802.11ax™-2021. The basic trigger frame 1144 may specify the transmitted AC or ACs from which data are allowed to be transmitted by the triggered non-AP MLDs during the frame exchange. Alternatively, the triggered non-AP MLDs may locally determine the transmitted AC or ACs. In any case, non-AP MLD 120 via co-affiliated STA A1 121 transmits a HE TB (High-Efficiency Trigger-Based) PPDU 1124 in its allocated resource unit.

As a variant, affiliated AP1 111 may directly (without trigger frame) perform a DL transmission where AP MLD 110 via AP1 111 transmits a HE MU (High-Efficiency Multi-User) PPDU 1124′ over Link 151. The HE MU PPDU 1124′ may allocate resource units of Link 151 to various affiliated STAs, and provide PPDUs over each allocated resource unit.

After the end of this frame exchange plus an EMLSR Transition Delay or EMLMR Delay specified in the EML capabilities, non-AP MLD 120 switches back to the listening operation mode (step 950), meaning that co-affiliated STA A1 121 switches back to the listening operation state 1010 as well as the other co-affiliated STA A2 122 (listening operation state 1011).

At this stage, both co-affiliated STAs A1 121 and A2 122 can handle the restart of their backoff counter or counters. On FIG. 11, backoff counter restart 1132 of a backoff counter corresponding to a transmitted AC is represented for co-affiliated STA A1 121 for Link 151 and backoff counter restart 1133 for the same AC is represented for co-affiliated STA A2 122 for Link 152. Backoff counter restarts 1132 and 1133 correspond, respectively, to backoff counters BC[151,3] and BC[152,3] in the example. The other “not transmitted” backoff counters (i.e., not concerned by the frame exchange) are resumed from their current values, in a conventional way.

With reference to the table shown in FIG. 13, backoff counter restarts 1132 and 1133 for transmitted AC3 depend on the type (UL or DL) of the previous transmission and, in case of an UL transmission, on the status of this previous UL transmission of HE TB PPDU frames 1124. The case of FIG. 11 is shown in the second and third rows 1302 (for UL transmission) and 1303 (for DL transmission only).

Strategies for backoff counter restart 1132 of BC[151,3] are shown in column 1330.

In case where an UL transmission of AC3 data occurred during the frame exchange, if the previous MU UL transmission 1124 was successful, backoff counter BC[151,3] is handled in a legacy fashion: it is merely resumed from its current value and processed using the conventional EDCA backoff procedure, and then it may be re-initialized (at the first subsequent expiry) from range [0, CW=CWmin] using the MU EDCA parameters. This is to penalize non-AP MLD 120 from having benefited from the TB uplink transmission opportunity.

If the previous MU UL transmission 1124 was not successful, backoff counter BC[151,3] is handled in a legacy fashion: it is merely resumed from its current value and processed using the conventional EDCA backoff procedure.

In case where only MU DL transmission(s) of AC3 data occurred during the frame exchange, whatever the status of the previous MU DL transmission 1124′, backoff counter BC[151,3] is handled in a legacy fashion: it is merely resumed from its current value and processed using the conventional EDCA backoff procedure.

Strategies for backoff counter restart 1133 of BC[152,3] are shown in column 1340.

In case where an UL transmission of AC3 data occurred during the frame exchange, if the previous MU UL transmission 1124 was successful, plural options to restart backoff counter BC[152,3] are available, that can be indifferently used.

First option consists in re-initializing BC[152,3] from range [0, CW=CW] using current EDCA parameters and processing it using the conventional EDCA backoff procedure. In this case, BC[152,3] is re-initialized (and not merely resumed) to take into account its dependency from BC[151,3] and restore some fairness. However, as no UL transmission occurred from STA A2 122 on Link 152, the Contention Window CW keeps the same value to reflect the current status on this link.

Second option consists in re-initializing BC[152,3] from range [0, CW=CWmin] using MU EDCA parameters or EML EDCA parameters (as defined above), if not yet in the corresponding MU or EML EDCA mode (hence a switch into this mode is made), and processing it using the conventional EDCA backoff procedure. The MUEDCATimer or EMLEDCATimer may be set accordingly. In this case, BC[152,3] is re-initialized to take into account its dependency on BC[151,3] and uses MU or EML EDCA parameters to take into account the triggered based UL transmission 1124 for AC3.

Third option consists in resuming BC[152,3] from its current value and processing it using the conventional EDCA backoff procedure, and then in re-initializing it (at the first subsequent expiry) using either the first option (from range [0, CW]) or the second option (from range [0, CWmin] using MU or EML EDCA parameters), if not yet in the MU or EML EDCA mode.

If the previous MU UL transmission 1124 was not successful, backoff counter BC[152,3] is resumed from its current value and processed using the conventional EDCA backoff procedure. In this case, as the MU UL transmission 1124 was failed for AC3 on Link 151, the AC3 priority on Link 152 is kept as it is by merely resuming the corresponding backoff counter BC[152,3] from its current value.

In case where only MU DL transmission(s) of AC3 data occurred during the frame exchange, whatever the status of the previous MU DL transmission 1124′, backoff counter BC[152,3] is resumed from its current value and processed using the conventional EDCA backoff procedure. In this case, as the previous MU DL transmission 1124′ was a downlink transmission, the backoff counter BC[152,3], being mapped onto AC3 related to an uplink traffic, is resumed from its current value.

The optional synchronization delay 1040 of FIG. 10b may also be implemented in the scenario of FIG. 11 to compensate for the possible loss of synchronization of co-affiliated STA A2 122 being in the disabled frame exchange state 1021.

FIG. 12 schematically illustrates an exemplary timeline of a third EMLSR or EMLMR operation case involving a backoff restart procedure according to embodiments of the invention when the triggering event of the frame exchange is the reception of an initial frame (in the EMLMR mode) or initial control frame (in the EMLSR mode) over Link 151 from the AP MLD. In this scenario, the frame exchange related to the transmitted AC is made over Link 151 after an initial frame is received while no backoff counter for that transmitted AC is decremented for that link but backoff counters driving EDCA for the same transmitted AC to the other Link 152 is being decremented.

As described above (step 910), decision on which backoff counters have to be decremented may be based on various criteria.

The scenario of FIG. 12 particularly applies when the TID-to-Link mapping forbids an AC (e.g. AC3 in the example) on Link 151 but a trigger frame sent by the AP MLD 110 in the frame exchange allows this AC in the TB MU UL transmission.

The scenario of FIG. 12 also applies when the decrement of a backoff counter cannot be started before the Initial frame 1134 is received. This may be the case when the AIFSN value governing the behaviour of that backoff counter has a high value. Incidentally, this also applies when AIFSN=0 which defines a specific MU EDCA mode where EDCA is disabled for the AC (e.g. AC3 in the example) on Link 151. Indeed, according to 802.11ax™-2021, an MU AC Parameter Record field of an MU EDCA Parameter Set element may contain a value 0 in the ACI/AIFSN field, therefore indicating that EDCA is disabled for the duration specified by the MUEDCATimer for the corresponding AC.

Therefore, the backoff counter of one AC may be decremented for Link 2 while the corresponding backoff counter of the same AC for Link 1 is not decremented.

In FIG. 12, only one backoff counter (corresponding to the transmitted AC from which data are to be transmitted during the frame exchange) is shown that is decremented by co-affiliated STA A2 122 operating on Link 152 (step 915 above). However, multiple transmitted backoff counters may be decremented simultaneously by co-affiliated STA A2 122 while the corresponding backoff counters for the same transmitted ACs are not decremented by co-affiliated STA A1 121 operating on Link 151. In the example, BC[152,3] is decremented. Similar to FIG. 10a, the other backoff counters BC[152,0], BC[152,1], BC[152,2] for the other ACs are also decremented concurrently to BC[152,3], as well as possibly the other backoff counters (not corresponding to AC3) BC[151,0], BC[151,1], BC[151,2] of co-affiliated STA A1 121.

While being in the listening operation state 1010, co-affiliated STA A1 121 receives Initial Control frame (IC) or Initial frame 1134 from affiliated AP AP1 111 over Link 151. In parallel, co-affiliated STA A2 122 decrements its backoff counter or counters 1014.

Responsive to such reception, non-AP MLD 120 suspends backoff counter decrement 1014 (steps 925, 930), initiates a state change of the co-affiliated STAs (step 935) and then sends Initial Control frame response (IC resp.) or Initial frame response 1135 to affiliated AP AP1 111.

After an EMLSR active switch delay or EMLMR active switch delay, co-affiliated STA A1 121 has switched from the listening operation state 1010 to the enabled frame exchange state 1020 while co-affiliated STA A2 122 has switched simultaneously from the listening operation state 1011 to the disabled frame exchange state 1021.

Once the switches have been made, co-affiliated STA A1 121 performs the frame exchange with affiliated AP AP1 111 over Link 151.

Typically, affiliated AP1 111 may transmit a basic trigger frame 1144 to co-affiliated STA A1 121 in order to allocate uplink (UL) resources units for non-AP MLD 120 as specified in IEEE Std 802.11ax™-2021. The basic trigger frame 1144 may specify the transmitted AC or ACs (here AC3). Alternatively, the triggered non-AP MLDs may locally determine the transmitted AC or ACs. In any case, non-AP MLD 120 via co-affiliated STA A1 121 transmits a HE TB (High-Efficiency Trigger-Based) PPDU 1124 in its allocated resource unit.

As a variant, affiliated AP1 111 may directly (without trigger frame) perform a DL transmission where AP MLD 110 via AP1 111 transmits a HE MU (High-Efficiency Multi-User) PPDU 1124′ over Link 151. The HE MU PPDU 1124′ may allocate resource units of Link 151 to various affiliated STAs, and provide PPDUs over each allocated resource unit.

After the end of this frame exchange plus an EMLSR Transition Delay or EMLMR Delay specified in the EML capabilities, non-AP MLD 120 switches back to the listening operation mode (step 950), meaning that co-affiliated STA A1 121 switches back to the listening operation state 1010 as well as the other co-affiliated STA A2 122 (listening operation state 1011).

At this stage, co-affiliated STA A2 122 can handle the restart of its transmitted backoff counter or counters. On FIG. 12, backoff counter restart 1233 corresponding to the backoff counter BC[152,3] is represented for co-affiliated STA A2 122 for Link 152.

As for FIG. 11, backoff counter restart 1233 for AC3 depends on the type (UL or DL) of the previous transmission and, in case of an UL transmission, on the status of this previous UL transmission of HE TB PPDU frames 1124. Again, the restart strategies available in this case are shown in the boxes where the last column 1340 crosses the second and third rows 1302 (for UL transmission) and 1303 (for DL transmission only), in FIG. 13. The restart strategies are not repeated here for concision reasons.

FIG. 13 illustrates a table 1300 gathering proposed EDCA backoff counter restart procedures or policies according to embodiments of the invention.

Column 1310 gathers exemplary triggering events that may interrupt the backoff counter decrements. Column 1320 indicates, for each event, the possible uplink transmission statuses. Column 1330 gathers, for each event and each transmission status, one or more backoff counter restart strategies to apply for the transmitted AC or ACs, i.e. for BC[151,3] in the examples above. Column 1340 gathers, for each event and each transmission status, one or more backoff counter restart strategies to apply for the transmitted AC or ACs, i.e. for BC[152,3] in the examples above.

Row 1301 gathers backoff counter restart strategies to apply for the transmitted AC or ACs in case of SU UL transmissions, i.e. when the triggering event interrupting the backoff counter decrements is the expiry of one backoff counter contending access to Link 151.

Row 1302 gathers backoff counter restart strategies to apply for the transmitted AC or ACs in case of TB MU UL transmissions, i.e. when the triggering event interrupting the backoff counter decrements is the reception of an Initial frame or Initial Control frame on Link 151 followed by a triggered based uplink traffic.

Row 1303 gathers backoff counter restart strategies to apply for the transmitted AC or ACs in case of MU DL transmissions, i.e. when the triggering event interrupting the backoff counter decrements is the reception of an Initial frame or Initial Control frame on Link 151 followed by a downlink traffic.

FIG. 14 schematically illustrates an EMLSR capable architecture for an MLD. This Figure takes the example of two affiliated non-AP STAs sharing the hardware resources of their non-AP MLD when the EMLSR mode is activated. The EMLSR capable architecture for an MLD presented in this Figure is for illustrative purpose only and other alternative architectures may be contemplated.

The architecture comprises two radio stacks, a Light radio stack and a Full radio stack.

The full radio stack comprises a full 802.11be MAC module 1400a (exchanging data with higher layers), a full 802.11be PHY module 1405a connected with the full MAC module, a full radio-frequency chain 1415a connected with the full PHY module and the antennas 1420a connected with the full RF chain through an EMLSR switch 1410.

The light radio stack comprises a light 802.11be MAC module 1400b (exchanging data with higher layers), a light 802.11be PHY module 1405b connected with the light MAC module, a light radio-frequency chain 1415b connected with the light PHY module and the antennas 1420b connected with the light RF chain through the EMLSR switch 1410.

The EMLSR switch 1410 is shared by the two radio stacks and configured to switch, when the EMLSR mode is activated, the EMLSR co-affiliated STAs from/to Listening operation state to/from Enable or Disable Frame Exchange states.

The radio chain 1400a/1405a/1415a is a full radio resource allowing reception and transmission of any IEEE802.11 frames. In particular, it includes encoding and decoding modules to encode and decode any IEEE802.11 frames. On the other hand, the radio chain 1400b/1405b/1415b is a reduced function (or “light”) radio resource which only allows reception and transmission of specific IEEE802.11 frames. In particular, it only includes encoding and decoding modules to encode and decode specific frames using a rate of 6 Mbps, 12 Mbps, or 24 Mbps.

The diagram on the bottom left illustrates the functioning of the MLD when the non-AP MLD is in the EMLMR listening operation mode: the common EMLSR switch 1410 connects each radio chain 1400a/1405a/1415a and 1400b/1405b/1415b to antennas 1420a and 1420b, respectively. Hence, each radio stack can be used to simultaneously listen to a respective link. As shown in the Figure, two links are available. The full radio chain 1400a/1405a/1415a and antennas 1420a are configure to operate on the Link1, the light radio chain 1400b/1405b/1415b and antennas 1420b are configured to operate on the Link2.

The diagram on the bottom center illustrates the functioning of the MLD when the non-AP MLD switches in a first EMLSR frame exchange mode. The EMLSR co-affiliated STA corresponding to Link 1 is in the enabled frame exchange state, while the other EMLSR co-affiliated STA corresponding to Link 2 is in the disabled frame exchange state. In that case, the common EMLSR switch 1410 connects the full radio chain 1400a/1405a/1415a to both antennas 1420a and 1420b and the full radio chain 1400a/1405a/1415a and antennas 1420a/1420b are configured to operate on the Link1. Here, as the full radio chain remains configured to operate on Link 1, the EMLSR switch duration from Listening operation state to Enable frame exchange state may be considered as short. Indeed, in this case, the switch only involves an antenna switch. In the meantime, the common EMLSR switch 1410 disconnects the light radio chain 1400b/1405b/1415b from the antennas 1420b. In this configuration, the light radio chain 1400b/1405b/1415b is not able to received or transmit any frame on Link 2. Then, only Link 1 is available.

The diagram on the bottom right illustrates the functioning of the MLD when the non-AP MLD switches in a second EMLSR frame exchange mode. The EMLSR co-affiliated STA corresponding to Link 2 is in the enabled frame exchange state, while the other EMLSR co-affiliated STA corresponding to Link 1 is in the disabled frame exchange state. In that case, the common EMLSR switch 1410 connects the full radio chain 1400a/1405a/1415a to both antennas 1420a and 1420b and the full radio chain 1400a/1405a/1415a and antennas 1420a/1420b are configured to operate on the Link2. Here, as the full radio chain switches to operate on Link 2, the EMLSR switch duration from Listening operation state to Enable frame exchange state may be considered as long. Indeed, in this case, the switch involves both an antenna switch and the full radio chain configuration switch. In the meantime, the common EMLSR switch 1410 disconnects the light radio chain 1400b/1405b/1415b from the antennas 1420b. In this configuration, the light radio chain 1400b/1405b/1415b is not able to received or transmit any frame on Link 1. Then, only Link 2 is available.

The functioning of the common EMLSR switch 1410 clearly shows that the change of states for two EMLSR co-affiliated STAs in the same MLD is necessarily simultaneous because the antenna resources are either connected to one of the STAs or to the other, but never remains available for both STAs at the same time.

FIG. 15 schematically illustrates an EMLMR capable architecture for an MLD. This Figure takes the example of two affiliated non-AP STAs sharing their antenna resources when the EMLMR mode is activated.

The architecture comprises two radio stacks, one for each non-AP STA.

A radio stack comprises a full 802.11be MAC module 1500a or 1500b (exchanging data with higher layers), a full 802.11be PHY module 1505a or 1505b connected with the MAC module, a radio-frequency chain 1515a or 1515b connected with the PHY module, an EMLMR switch 1510 shared by the two radio stacks and configured to perform the aggregation of the antenna resources when the EMLMR mode is activated, and an antenna array 1520a or 1520b.

The diagram on the bottom left illustrates the functioning when the non-AP MLD is listening to an initial frame: the common EMLMR switch 1510 connects each antenna array to its RF chain. Hence, each radio stack is complete and can serve a respective link using for example a 2×2 MIMO antenna configuration. As shown in the Figure, two links are available.

The diagram on the bottom center illustrates the functioning of the MLD when the non-AP MLD switches in a first EMLMR frame exchange mode. The EMLMR co-affiliated STA corresponding to Link 2 is in the enabled frame exchange state, while the other EMLMR co-affiliated STA corresponding to Link 1 is in the disabled frame exchange state. The common EMLMR switch 1510 aggregates the antenna resource to Link 2. To do so, it connects the antenna array 1520a of the second radio stack to the RF chain 1515b of the first radio stack. Hence, the first radio stack can operate in a 4×4 MIMO antenna configuration to improve the throughput over Link 2. On the other hand, Link 1 can no longer be used as its antenna array 1520a is no longer available for the second radio stack.

The diagram on the bottom right illustrates the functioning of the MLD when the non-AP MLD switches in a second EMLMR frame exchange mode. The EMLMR co-affiliated STA corresponding to Link 1 is in the enabled frame exchange state, while the other EMLMR co-affiliated STA corresponding to Link 2 is in the disabled frame exchange state. The common EMLMR switch 1510 aggregates the antenna resource to Link 1. To do so, it connects the antenna array 1520b of the first radio stack to the RF chain 1515a of the second radio stack. Hence, the second radio stack can operate in a 4×4 MIMO antenna configuration to improve the throughput over Link 1. On the other hand, Link 2 can no longer be used as its antenna array 1520b is no longer available for the first radio stack.

The functioning of the common EMLMR switch 1510 clearly shows that the change of states for two EMLMR co-affiliated STAs in the same MLD is necessarily simultaneous because the antenna resources are either connected to one of the STAs or to the other, but never remain available for both STAs at the same time.

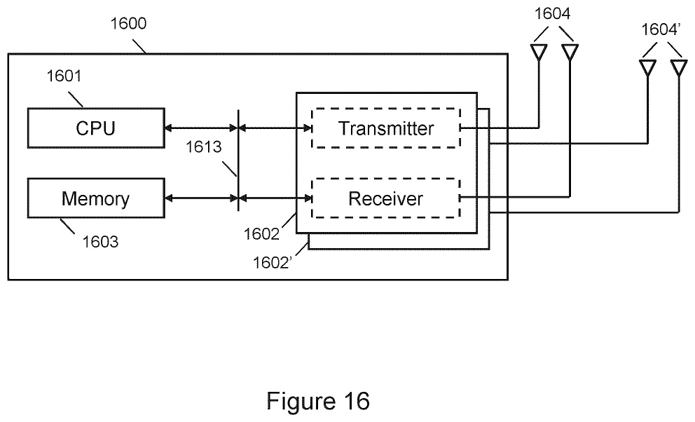

FIG. 16 schematically illustrates a communication device 1600, typically any of the MLDs discussed above, of a wireless network, configured to implement at least one embodiment of the present invention. The communication device 1600 may preferably be a device such as a micro-computer, a workstation or a light portable device. The communication device 1600 comprises a communication bus 1613 to which there are preferably connected:
a central processing unit 1601, such as a processor, denoted CPU;
a memory 1603 for storing an executable code of methods or steps of the methods according to embodiments of the invention as well as the registers adapted to record variables and parameters necessary for implementing the methods; and
at least two communication interfaces 1602 and 1602′ connected to the wireless communication network, for example a communication network according to one of the IEEE 802.11 family of standards, via transmitting and receiving antennas 1604 and 1604′, respectively.

Preferably the communication bus 1613 provides communication and interoperability between the various elements included in the communication device 1600 or connected to it. The representation of the bus is not limiting and in particular the central processing unit is operable to communicate instructions to any element of the communication device 1600 directly or by means of another element of the communication device 1600.

The executable code may be stored in a memory that may either be read only, a hard disk or on a removable digital medium such as for example a disk. According to an optional variant, the executable code of the programs can be received by means of the communication network, via the interface 1602 or 1602′, in order to be stored in the memory of the communication device 1600 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless network, comprising, at a non-access point (non-AP), multi-link device (MLD) operating in an active Enhanced Multi-Link (EML) mode:
invoking, by a first station (STA), affiliated with the non-AP MLD and corresponding to a first link of a set of enabled links in which links the EML mode is applied, an enhanced distributed channel access (EDCA), backoff procedure decrementing a backoff counter, to access the first link; and
switching the first affiliated STA from a listening operation state to an enabled frame exchange state for initiating a frame exchange with an AP MLD over the first link.

2. The method of claim 1, wherein switching the first affiliated STA to the enabled frame exchange state is performed before invoking, by the first affiliated STA in the enabled frame exchange state, the EDCA backoff procedure for decrementing the backoff counter.

3. The method of claim 2, further comprising, upon detecting the first link becomes busy during the decrement of the backoff counter, suspending the decrement and applying one policy from amongst:
a) keeping the first affiliated STA in the enabled frame exchange state and resuming the decrement once the first link becomes idle again,
b) switching the first affiliated STA back to the listening operation state regardless of a duration specified in a frame based on which the detection is made,
c) switching the first affiliated STA back to the listening operation state for a predefined time period that is based on a duration specified in a frame based on which the detection is made, before switching again to the enabled frame exchange state to resume the decrement if the first link is idle again, and
d) determining a duration specified in a frame based on which the detection is made, and depending on the determined duration, deciding to apply one or the other of policies a), b) or c).

4. The method of claim 1, wherein switching the first affiliated STA to the enabled frame exchange state is performed when the backoff counter reaches a value of 0.

5. The method of claim 1, further comprising suspending the EDCA backoff procedure upon receiving an initial frame from the AP MLD over a second link of the set.

6. The method of claim 1, further comprising, upon receiving an initial frame from the AP MLD over a second link of the set, deciding whether or not to suspend the EDCA backoff procedure based on one criterion from amongst:
determining whether the first affiliated STA is allocated a full radio resource,
determining whether the initial frame is a MU-RTS Trigger frame,
determining whether uplink data have already been preloaded in a transmission associated to the first link only, and
determining whether an amount of buffered data is higher than a threshold.

7. The method of claim 1, wherein switching the first affiliated STA includes invoking a state switching procedure for the first affiliated STA while the first affiliated STA is decrementing the backoff counter so that the state switching procedure ends simultaneously to the backoff counter reaching the value of 0.

8. The method of claim 1, wherein switching the first affiliated STA includes invoking a state switching procedure for the first affiliated STA, responsive to the backoff counter reaching the value of 0.

9. The method of claim 8, further comprises, responsive to the backoff counter reaching the value of 0, transmitting a control frame over the first link.

10. The method of claim 9, wherein the control frame is a CTS-to-self frame or a RTS frame.

11. The method of claim 9, wherein the control frame includes padding to end the control frame after a time point that precedes an end of the state switching procedure by a short interframe space (SIFS).

12. The method of claim 4, wherein the first affiliated STA is allocated a full radio resource in the listening operation state.

13. The method of claim 1, comprising setting a network allocation vector (NAV), of the first affiliated STA in the listening operation state, upon sensing over the first link any control frame having a MCS value up to 2.

14. The method of claim 1, comprising simultaneously invoking EDCA backoff procedures on two or more links of the set, wherein the first link is the link corresponding to a backoff counter of the EDCA backoff procedures that first reaches the value of 0.

15. The method of claim 1, further comprising, simultaneously to the switching of the first affiliated STA, switching a separate and second STA affiliated with the non-AP MLD and corresponding to a second link of the set, from a listening operation state to a disabled frame exchange state.

16. The method of claim 15, further comprising switching the first and second affiliated STAs back to the listening operation state upon ending the frame exchange over the first link.

17. The method of claim 1- or 3, wherein initiating the frame exchange excludes transmitting an initial frame to the AP MLD over the first link.

18. The method of claim 1, further comprising performing the frame exchange with the AP MLD over the first link, after the backoff counter reaches a value of 0.

19. The method of claim 1, wherein, responsive to starting a frame exchange with the AP MLD over a second link of the set of enabled links in which links the EML mode is applied, suspending the backoff counter driving the EDCA to the first link of the set.

20-44. (canceled)

45. A non-access point (non-AP), multi-link device (MLD), capable of operating in an active Enhanced Multi-Link (EML) mode, the non-AP MLD comprising:
means for invoking, by a first station, STA, affiliated with the non-AP MLD and corresponding to a first link of a set of enabled links in which links the EML mode can be applied, an enhanced distributed channel access (EDCA), backoff procedure decrementing a backoff counter, to access the first link; and
means for switching the first affiliated STA from a listening operation state to an enabled frame exchange state for initiating a frame exchange with an AP MLD over the first link.

46. A non-transitory computer-readable medium storing a program which, when executed by a microprocessor or computer system in a wireless device, causes the wireless device to perform the method of claim 1.
